(19) United States
(12) Patent Application Publication
(10) Pub. No.: US 2024/0027598 A1
(43) Pub. Date: Jan. 25, 2024

(54) Identifying Motion Zones Based on User Input and Motion-Sensing Data Derived from Wireless Signals

(71) Applicant: Cognitive Systems Corp., Waterloo (CA)

(72) Inventor: Mohammad Omer, Waterloo (CA)

(73) Assignee: Cognitive Systems Corp., Waterloo (CA)

(21) Appl. No.: 18/356,075

(22) Filed: Jul. 20, 2023

Related U.S. Application Data
(60) Provisional application No. 63/391,178, filed on Jul. 21, 2022.

(51) Int. Cl. G01S 13/56; H04W 4/021; G01S 7/00; G01S 13/00

(52) U.S. Cl. CPC G01S 13/56; H04W 4/021; G01S 7/006; G01S 13/003; G01S 13/89

(57) ABSTRACT

In a general aspect, a plurality of motion zones are identified in a motion detection system. Each of the plurality of motion zones represents a distinct region in a space associated with a wireless communication network, and at least a subset of the motion zones are associated with respective wireless communication devices in the wireless communication network. Motion-sensing data is generated based on first wireless signals transmitted during a first time period between pairs of wireless communication devices. The motion-sensing data represents motion in the space. A new motion zone is identified based on the motion-sensing data; the new motion zone is not associated with any of the wireless communication devices. User input is received in response to a graphical representation of the new motion zone being displayed on a display device. The motion detection system is updated based on the user input.

### CROSS-REFERENCE TO RELATED APPLICATIONS

This patent application claims priority to, and incorporates by reference the entire disclosure of, U.S. Provisional Application No. 63/391,176, filed on Jul. 21, 2022.

### BACKGROUND

The following description relates to identifying motion zones based on user input and motion-sensing data derived from wireless signals.

Motion detection systems have been used to detect movement, for example, of objects in a room or an outdoor area. In some example motion detection systems, infrared or optical sensors are used to detect movement of objects in the sensor's field of view. Motion detection systems have been used in security systems, automated control systems, and other types of systems.

### DESCRIPTION OF DRAWINGS

FIG. 1 is a diagram showing an example wireless communication system;

FIGS. 2A-2B are diagrams showing example wireless signals communicated between wireless communication devices;

FIG. 2C is a diagram showing an example wireless sensing system operating to detect motion in a space;

FIG. 3A is a schematic diagram of an example wireless communication network;

FIG. 3B is a diagram showing an example graphical display on a user interface on a user device;

FIG. 4A is a diagram of an example space associated with a wireless communication network;

FIG. 4B a diagram of an example spatial map based on the example space of FIG. 4A;

FIG. 5A is a diagram of an example space associated with a wireless communication network;

FIG. 5B is an example of a transition matrix illustrating the addition of motion zones that are not associated with a wireless communication device;

FIG. 5C is an example spatial map based on the example space shown in FIG. 5A illustrating locations of new motion zones;

FIG. 6 is a block diagram of a method of determining significance of link-disturbance signatures;

FIG. 7 is a flow diagram of a method for identifying motion zones that are not associated with a wireless communication device;

FIG. 8A is a flow chart of an example process for determining a location of motion detected by one or more wireless links in a wireless communication network;

FIG. 8B is a block diagram illustrating interaction of a user with a motion detection system;

FIG. 8C is a signaling and flow diagram representing example operations that may be performed in the system shown in FIG. 8B; and

FIG. 9 is a block diagram showing an example wireless communication device.

### DETAILED DESCRIPTION

In some aspects of what is described here, a wireless sensing system can process wireless signals (e.g., radio frequency signals) transmitted through a space between wireless communication devices for wireless sensing applications. Example wireless sensing applications include detecting motion, which can include one or more of the following: detecting motion of objects in the space, motion tracking, localization of motion in a space, breathing detection, breathing monitoring, presence detection, gesture detection, gesture recognition, human detection (e.g., moving and stationary human detection), human tracking, fall detection, speed estimation, intrusion detection, walking detection, step counting, respiration rate detection, sleep pattern detection, sleep quality monitoring, apnea estimation, posture change detection, activity recognition, gait rate classification, gesture decoding, sign language recognition, hand tracking, heart rate estimation, breathing rate estimation, room occupancy detection, human dynamics monitoring, and other types of motion detection applications. Other examples of wireless sensing applications include object recognition, speaking recognition, keystroke detection and recognition, tamper detection, touch detection, attack detection, user authentication, driver fatigue detection, traffic monitoring, smoking detection, school violence detection, human counting, metal detection, human recognition, bike localization, human queue estimation, Wi-Fi imaging, and other types of wireless sensing applications. For instance, the wireless sensing system may operate as a motion detection system to detect the existence and location of motion based on Wi-Fi signals or other types of wireless signals.

The examples described herein may be useful for home monitoring. In some instances, home monitoring using the wireless sensing systems described herein may provide several advantages, including full home coverage through walls and in darkness, discreet detection without cameras, higher accuracy and reduced false alerts (e.g., in comparison with sensors that do not use Wi-Fi signals to sense their environments), and adjustable sensitivity. By layering Wi-Fi motion detection capabilities into routers and gateways, a robust motion detection system may be provided.

The examples described herein may also be useful for wellness monitoring. Caregivers want to know their loved ones are safe, while seniors and people with special needs want to maintain their independence at home with dignity. In some instances, wellness monitoring using the wireless sensing systems described herein may provide a solution that uses wireless signals to detect motion without using cameras or infringing on privacy, generates alerts when unusual activity is detected, tracks sleep patterns, and generates preventative health data. For example, caregivers can monitor motion, visits from health care professionals, and unusual behavior such as staying in bed longer than normal. Furthermore, motion is monitored unobtrusively without the need for wearable devices, and the wireless sensing systems described herein offer a more affordable and convenient alternative to assisted living facilities and other security and health monitoring tools.

The examples described herein may also be useful for setting up a smart home. In some examples, the wireless sensing systems described herein use predictive analytics and artificial intelligence (AI), to learn motion patterns and trigger smart home functions accordingly. Examples of smart home functions that may be triggered include adjusting the thermostat when a person walks through the front door, turning other smart devices on or off based on preferences, automatically adjusting lighting, adjusting HVAC systems based on present occupants, etc.

In some aspects of what is described here, a motion detection system includes a plurality of wireless communication devices placed throughout a physical space, such as a residence, a workplace, and so forth. The plurality of wireless communication devices is part of a wireless communication network and may include client devices, such as mobile devices, smartphones, smart watches, tablets, laptop computers, smart thermostats, wireless-enabled cameras, smart TVs, wireless-enabled speakers, wireless-enabled power sockets, and so forth. The plurality of wireless communication devices may also include wireless access points (APs) capable of connecting the client devices to the wireless communication network. In some variations, the plurality of wireless access points defines a wireless mesh network.

During operation, the plurality of wireless communication devices may be associated with respective media access control (MAC) that are unique to each wireless communication device (or wireless communication interface therein). However, the MAC addresses—which are typically represented by pairs of alphanumeric characters—do not indicate a positional information such as a location of a wireless communications device in the space or a distance of the wireless communication device relative to another wireless communication device. As such, a user of the motion detection system is unable to perceive the space in which the one or more wireless communication devices reside based on the MAC addresses.

However, the motion detection system may be configured to generate motion-sensing data based on wireless signals exchanged between the plurality of wireless communication devices. The wireless signals may be transmitted across wireless links defined by respective pairs of wireless communication devices in the wireless communication network. Moreover, the wireless links may extend through respective portions of the space. As such, the motion of an object or person in the space may disturb one or more wireless signals and thus allow the motion detection system to generate the motion-sensing data. The motion detection system uses the motion-sensing data to localize the motion of the object or person in the space. In many instances, the motion detection system informs the user where motion is happening in the space by identifying one or more wireless communication devices closest to the motion. Such identification may be made based on a spatial map of the wireless communication devices in the space. The spatial map may assist the user in perceiving the space and motion therein.

The motion detection system may generate the spatial map during an initial period of operation (e.g., a few hours). In doing so, the motion detection system may collect motion-sensing data and then use the collected motion-sensing data to determine the locations of the plurality of communication devices relative to each other. The locations may correspond to physical or logical distances between respective pairs of wireless communication devices. The physical or logical distances may be based on, respectively, a physical or logical coordinate system for the spatial map.

The motion detection system is also configured to present the spatial map to the user (e.g., via a display device) to allow the user to input information that defines additional features of the space. For example, the user may input information associating groups of wireless communication devices that share a common characteristic (e.g., devices that are in the same room). After receiving this input, the motion detection system may generate configuration data (e.g., motion zones) that represents these additional features. The configuration data may be subsequently used by the motion detection system to display information on a graphical interface that represents the spatial map with its additional features. The configuration data may also be used by the motion detection system to conduct an operation (e.g., send a notification to the user) based on the additional features.

In some implementations, the motion detection system is configured to receive instructions from the user to assign one or more wireless communication devices on the spatial map to a motion zone in the space. The motion zone may be based on a region shared in common by the one or more wireless communication devices. For example, the space may be a house that includes a living room having multiple wireless communication devices therein. If motion occurs in the living room, the user may prefer to know that the motion occurred in the living room instead of at a specific wireless communication device in the living room. In this case, the user may instruct the motion detection system to create a motion zone entitled “living room” and assign the multiple wireless communication devices to this motion zone. The motion zone and its associated room may correspond to additional features provided by the user for the spatial map. If desired, the user may repeat this process for other rooms in the house and thus add further features to the spatial map. The motion detection system may then generate configuration data based on the information that will later assist the user perceiving motion detected in the house.

In some implementations, the motion detection system is configured to identify new motion zones that are not associated with any of the wireless communication devices in the system. For example, the motion detection system may determine that subsets of motion-sensing data are statistically significant and do not correspond to an existing motion zone. Based on the subset of motion-sensing data, the motion sensing may identify a possible new motion zone that can be added to the motion detection system. The motion detection system may determine a location of the new motion sensing zone, and present the new motion zone to a user in a spatial map. Along with the location of the new motion zone, the spatial map may indicate the locations of existing motion zones, the locations of wireless communication devices, and other location information, so that the user can determine whether to accept the new motion zone or what to name the new motion zone.

In some instances, aspects of the systems and techniques described here provide technical improvements and advantages over existing approaches. For example, the systems and techniques allow a motion sensing system to identify new motion zones that are not associated with a particular wireless communication device, and to obtain user input based on a graphical presentation of the new motion zone in a spatial map of the wireless communication devices. The spatial map provides a more intuitive representation of the new motion zone, allowing the user to understand the spatial relationship between the new motion zone and existing ones. As another example, the systems and techniques relieve the user from having to manually add motion zones or construct spatial maps. Instead, the motion detection system constructs the spatial map and identifies new motion zones based on the motion-sensing data. The motion zones can then be refined by the user. The technical improvements and advantages achieved in examples where the wireless sensing system is used for motion detection may also be achieved in other examples where the wireless sensing system is used for other wireless sensing applications.

In some instances, a wireless sensing system can be implemented using a wireless communication network. Wireless signals received at one or more wireless communication devices in the wireless communication network may be analyzed to determine channel information for the different communication links (between respective pairs of wireless communication devices) in the network. The channel information may be representative of a physical medium that applies a transfer function to wireless signals that traverse a space. In some instances, the channel information includes a channel response. Channel responses can characterize a physical communication path, representing the combined effect of, for example, scattering, fading, and power decay within the space between the transmitter and receiver. In some instances, the channel information includes beamforming state information (e.g., a feedback matrix, a steering matrix, channel state information (CSI), etc.) provided by a beamforming system. Beamforming is a signal processing technique often used in multi antenna (multiple-input/multiple-output (MIMO)) radio systems for directional signal transmission or reception. Beamforming can be achieved by operating elements in an antenna array in such a way that signals at particular angles experience constructive interference while others experience destructive interference.

The channel information for each of the communication links may be analyzed by one or more motion detection algorithms (e.g., running on a hub device, a client device, or other device in the wireless communication network, or on a remote device communicably coupled to the network) to detect, for example, whether motion has occurred in the space, to determine a relative location of the detected motion, or both. In some aspects, the channel information for each of the communication links may be analyzed to detect whether an object is present or absent, e.g., when no motion is detected in the space.

In some instances, a motion detection system returns motion data. In some implementations, motion data is a result that is indicative of a degree of motion in the space, the location of motion in the space, a time at which the motion occurred, or a combination thereof. In some instances, motion data may include data representing a position of the one or more wireless communication devices relative to each other. For example, the data may represent a distance between pairs of wireless communication devices in the wireless communication network. The distance may be based on a physical or logical coordinate system. In the latter case, the logical coordinate system may be used to indicate distances other than physical distances. In some instances, the motion data can include a motion score, which may include, or may be, one or more of the following: a scalar quantity indicative of a level of signal perturbation in the environment accessed by the wireless signals; an indication of whether there is motion; an indication of whether there is an object present; or an indication or classification of a gesture performed in the environment accessed by the wireless signals.

In some implementations, the motion detection system can be implemented using one or more motion detection algorithms. Example motion detection algorithms that can be used to detect motion based on wireless signals include the techniques described in U.S. Pat. No. 9,523,760 entitled “Detecting Motion Based on Repeated Wireless Transmissions,” U.S. Pat. No. 9,584,974 entitled “Detecting Motion Based on Reference Signal Transmissions,” U.S. Pat. No. 10,051,414 entitled “Detecting Motion Based On Decompositions Of Channel Response Variations,” U.S. Pat. No. 10,048,350 entitled “Motion Detection Based on Groupings of Statistical Parameters of Wireless Signals,” U.S. Pat. No. 10,108,903 entitled “Motion Detection Based on Machine Learning of Wireless Signal Properties,” U.S. Pat. No. 10,109,167 entitled “Motion Localization in a Wireless Mesh Network Based on Motion Indicator Values,” U.S. Pat. No. 10,109,168 entitled “Motion Localization Based on Channel Response Characteristics,” U.S. Pat. No. 10,743,143 entitled “Determining a Motion Zone for a Location of Motion Detected by Wireless Signals,” U.S. Pat. No. 10,605,908 entitled “Motion Detection Based on Beamforming Dynamic Information from Wireless Standard Client Devices,” U.S. Pat. No. 10,605,907 entitled “Motion Detection by a Central Controller Using Beamforming Dynamic Information,” U.S. Pat. No. 10,600,314 entitled “Modifying Sensitivity Settings in a Motion Detection System,” U.S. Pat. No. 10,567,914 entitled “Initializing Probability Vectors for Determining a Location of Motion Detected from Wireless Signals,” U.S. Pat. No. 10,565,860 entitled “Offline Tuning System for Detecting New Motion Zones in a Motion Detection System,” U.S. Pat. No. 10,506,384 entitled “Determining a Location of Motion Detected from Wireless Signals Based on Prior Probability,” U.S. Pat. No. 10,499,364 entitled “Identifying Static Leaf Nodes in a Motion Detection System,” U.S. Pat. No. 10,498,467 entitled “Classifying Static Leaf Nodes in a Motion Detection System,” U.S. Pat. No. 10,460,581 entitled “Determining a Confidence for a Motion Zone Identified as a Location of Motion for Motion Detected by Wireless Signals,” U.S. Pat. No. 10,459,076 entitled “Motion Detection based on Beamforming Dynamic Information,” U.S. Pat. No. 10,459,074 entitled “Determining a Location of Motion Detected from Wireless Signals Based on Wireless Link Counting,” U.S. Pat. No. 10,438,468 entitled “Motion Localization in a Wireless Mesh Network Based on Motion Indicator Values,” U.S. Pat. No. 10,404,387 entitled “Determining Motion Zones in a Space Traversed by Wireless Signals,” U.S. Pat. No. 10,393,866 entitled “Detecting Presence Based on Wireless Signal Analysis,” U.S. Pat. No. 10,380,856 entitled “Motion Localization Based on Channel Response Characteristics,” U.S. Pat. No. 10,318,890 entitled “Training Data for a Motion Detection System using Data from a Sensor Device,” U.S. Pat. No. 10,264,405 entitled “Motion Detection in Mesh Networks,” U.S. Pat. No. 10,228,439 entitled “Motion Detection Based on Filtered Statistical Parameters of Wireless Signals,” U.S. Pat. No. 10,129,853 entitled “Operating a Motion Detection Channel in a Wireless Communication Network,” U.S. Pat. No. 10,111,228 entitled “Selecting Wireless Communication Channels Based on Signal Quality Metrics,” and other techniques.

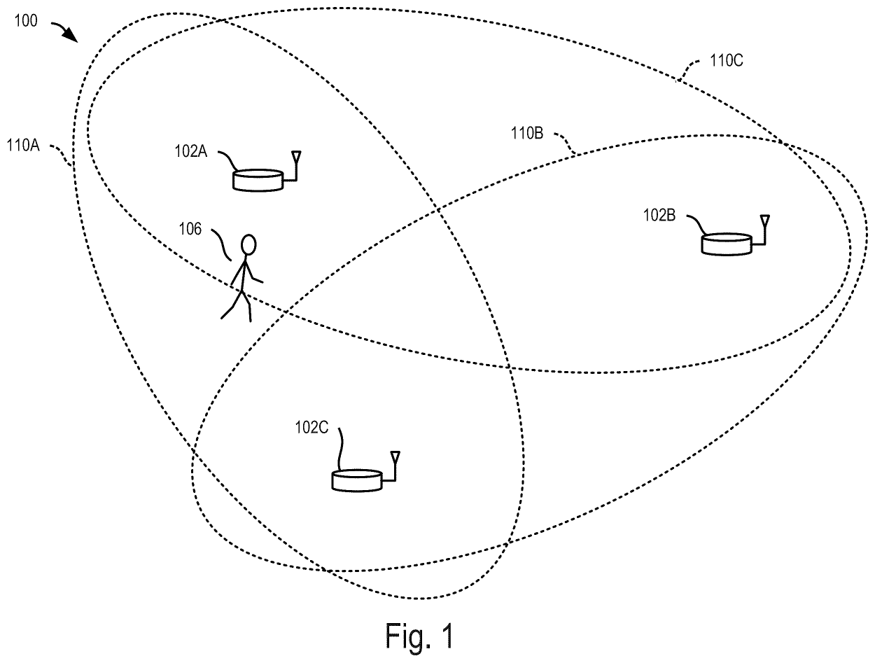

FIG. 1 illustrates an example wireless communication system 100. The wireless communication system 100 may perform one or more operations of a motion detection system. The technical improvements and advantages achieved from using the wireless communication system 100 to detect motion are also applicable in examples where the wireless communication system 100 is used for another wireless sensing application.

The example wireless communication system 100 includes three wireless communication devices 102A, 102B, 102C. The example wireless communication system 100 may include additional wireless communication devices 102 and/or other components (e.g., one or more network servers, network routers, network switches, cables, or other communication links, etc.).

The example wireless communication devices 102A, 102B, 102C can operate in a wireless network, for example, according to a wireless network standard or another type of wireless communication protocol. For example, the wireless network may be configured to operate as a Wireless Local Area Network (WLAN), a Personal Area Network (PAN), a metropolitan area network (MAN), or another type of wireless network. Examples of WLANs include networks configured to operate according to one or more of the 802.11 family of standards developed by IEEE (e.g., Wi-Fi networks), and others. Examples of PANs include networks that operate according to short-range communication standards (e.g., BLUETOOTH®, Near Field Communication (NFC), ZigBee), millimeter wave communications, and others.

In some implementations, the wireless communication devices 102A, 102B, 102C may be configured to communicate in a cellular network, for example, according to a cellular network standard. Examples of cellular networks include: networks configured according to 2G standards such as Global System for Mobile (GSM) and Enhanced Data rates for GSM Evolution (EDGE) or EGPRS; 3G standards such as Code Division Multiple Access (CDMA), Wideband Code Division Multiple Access (WCDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); 5G standards, and others.

In some cases, one or more of the wireless communication devices 102 is a Wi-Fi access point or another type of wireless access point (WAP). In some cases, one or more of the wireless communication devices 102 is an access point of a wireless mesh network, such as, for example, a commercially-available mesh network system (e.g., GOOGLE Wi-Fi, EERO mesh, etc.). In some instances, one or more of the wireless communication devices 102 can be implemented as wireless access points (APs) in a mesh network, while the other wireless communication device(s) 102 are implemented as leaf devices (e.g., mobile devices, smart devices, etc.) that access the mesh network through one of the APs. In some cases, one or more of the wireless communication devices 102 is a mobile device (e.g., a smartphone, a smart watch, a tablet, a laptop computer, etc.), a wireless-enabled device (e.g., a smart thermostat, a Wi-Fi enabled camera, a smart TV), or another type of device that communicates in a wireless network.

In the example shown in FIG. 1, the wireless communication devices transmit wireless signals to each other over wireless communication links (e.g., according to a wireless network standard or a non-standard wireless communication protocol), and the wireless signals communicated between the devices can be used as motion probes to detect motion of objects in the signal paths between the devices. In some implementations, standard signals (e.g., channel sounding signals, beacon signals), non-standard reference signals, or other types of wireless signals can be used as motion probes.

In the example shown in FIG. 1, the wireless communication link between the wireless communication devices 102A, 102C can be used to probe a first motion detection zone 110A, the wireless communication link between the wireless communication devices 102B, 102C can be used to probe a second motion detection zone 110B, and the wireless communication link between the wireless communication devices 102A, 102B can be used to probe a third motion detection zone 110C. In some instances, the motion detection zones 110 can include, for example, air, solid materials, liquids, or another medium through which wireless electromagnetic signals may propagate.

In the example shown in FIG. 1, when an object moves in any of the motion detection zones 110, the motion detection system may detect the motion based on signals transmitted through the relevant motion detection zone 110. Generally, the object can be any type of static or moveable object, and can be living or inanimate. For example, the object can be a human (e.g., the person 106 shown in FIG. 1), an animal, an inorganic object, or another device, apparatus, or assembly, an object that defines all or part of the boundary of a space (e.g., a wall, door, window, etc.), or another type of object.

In some examples, the wireless signals propagate through a structure (e.g., a wall) before or after interacting with a moving object, which may allow the object's motion to be detected without an optical line-of-sight between the moving object and the transmission or receiving hardware. In some instances, the motion detection system may communicate the motion detection event to another device or system, such as a security system or a control center.

In some cases, the wireless communication devices 102 themselves are configured to perform one or more operations of the motion detection system, for example, by executing computer-readable instructions (e.g., software or firmware) on the wireless communication devices. For example, each device may process received wireless signals to detect motion based on changes in the communication channel. In some cases, another device (e.g., a remote server, a cloud-based computer system, a network-attached device, etc.) is configured to perform one or more operations of the motion detection system. For example, each wireless communication device 102 may send channel information to a specified device, system, or service that performs operations of the motion detection system.

In an example aspect of operation, wireless communication devices 102A, 102B may broadcast wireless signals or address wireless signals to the other wireless communication device 102C, and the wireless communication device 102C (and potentially other devices) receives the wireless signals transmitted by the wireless communication devices 102A, 102B. The wireless communication device 102C (or another system or device) then processes the received wireless signals to detect motion of an object in a space accessed by the wireless signals (e.g., in the zones 110A, 11B). In some instances, the wireless communication device 102C (or another system or device) may perform one or more operations of a motion detection system.

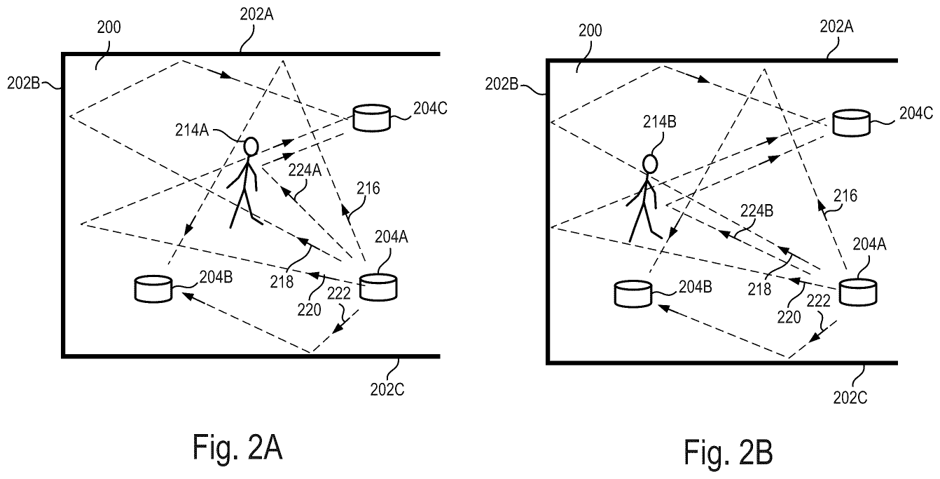

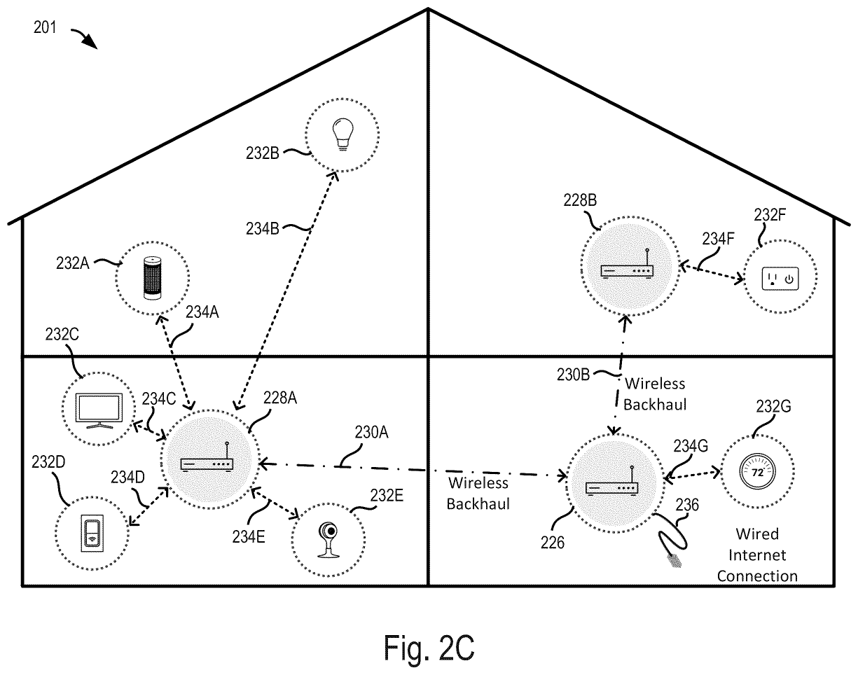

FIGS. 2A and 2B are diagrams showing example wireless signals communicated between wireless communication devices 204A, 204B, 204C. The wireless communication devices 204A, 204B, 204C can be, for example, the wireless communication devices 102A, 102B, 102C shown in FIG. 1, or may be other types of wireless communication devices.

In some cases, a combination of one or more of the wireless communication devices 204A, 204B, 204C can be part of, or may be used by, a motion detection system. The example wireless communication devices 204A, 204B, 204C can transmit wireless signals through a space 200. The example space 200 may be completely or partially enclosed or open at one or more boundaries of the space 200. The space 200 may be or may include an interior of a room, multiple rooms, a building, an indoor area, outdoor area, or the like. A first wall 202A, a second wall 202B, and a third wall 202C at least partially enclose the space 200 in the example shown.

In the example shown in FIGS. 2A and 2B, the first wireless communication device 204A transmits wireless motion probe signals repeatedly (e.g., periodically, intermittently, at scheduled, unscheduled, or random intervals, etc.). The second and third wireless communication devices 204B, 204C receive signals based on the motion probe signals transmitted by the wireless communication device 204A.

As shown, an object is in a first position 214A at an initial time (to) in FIG. 2A, and the object has moved to a second position 214B at subsequent time (ti) in FIG. 2B. In FIGS. 2A and 2B, the moving object in the space 200 is represented as a human, but the moving object can be another type of object. For example, the moving object can be an animal, an inorganic object (e.g., a system, device, apparatus, or assembly), an object that defines all or part of the boundary of the space 200 (e.g., a wall, door, window, etc.), or another type of object. In the example shown in FIGS. 2A and 2B, the wireless communication devices 204A, 204B, 204C are stationary and are, consequently, at the same position at the initial time to and at the subsequent time ti. However, in other examples, one or more of the wireless communication devices 204A, 204B, 204C are mobile and may move between initial time to and subsequent time ti.

As shown in FIGS. 2A and 2B, multiple example paths of the wireless signals transmitted from the first wireless communication device 204A are illustrated by dashed lines. Along a first signal path 216, the wireless signal is transmitted from the first wireless communication device 204A and reflected off the first wall 202A toward the second wireless communication device 204B. Along a second signal path 218, the wireless signal is transmitted from the first wireless communication device 204A and reflected off the second wall 202B and the first wall 202A toward the third wireless communication device 204C. Along a third signal path 220, the wireless signal is transmitted from the first wireless communication device 204A and reflected off the second wall 202B toward the third wireless communication device 204C. Along a fourth signal path 222, the wireless signal is transmitted from the first wireless communication device 204A and reflected off the third wall 202C toward the second wireless communication device 204B.

In FIG. 2A, along a fifth signal path 224A, the wireless signal is transmitted from the first wireless communication device 204A and reflected off the object at the first position 214A toward the third wireless communication device 204C. Between time to in FIG. 2A and time ti in FIG. 2B, the object moves from the first position 214A to a second position 214B in the space 200 (e.g., some distance away from the first position 214A). In FIG. 2B, along a sixth signal path 224B, the wireless signal is transmitted from the first wireless communication device 204A and reflected off the object at the second position 214B toward the third wireless communication device 204C. The sixth signal path 224B depicted in FIG. 2B is longer than the fifth signal path 224A depicted in FIG. 2A due to the movement of the object from the first position 214A to the second position 214B. In some examples, a signal path can be added, removed, or otherwise modified due to movement of an object in a space.

The example wireless signals shown in FIGS. 2A and 2B can experience attenuation, frequency shifts, phase shifts, or other effects through their respective paths and may have portions that propagate in another direction, for example, through the walls 202A, 202B, and 202C. In some examples, the wireless signals are radio frequency (RF) signals. The wireless signals may include other types of signals.

The transmitted signal can have a number of frequency components in a frequency bandwidth, and the transmitted signal may include one or more bands within the frequency bandwidth. The transmitted signal may be transmitted from the first wireless communication device 204A in an omnidirectional manner, in a directional manner, or otherwise. In the example shown, the wireless signals traverse multiple respective paths in the space 200, and the signal along each path can become attenuated due to path losses, scattering, reflection, or the like and may have a phase or frequency offset.

As shown in FIGS. 2A and 2B, the signals from various paths 216, 218, 220, 222, 224A, and 224B combine at the third wireless communication device 204C and the second wireless communication device 204B to form received signals. Because of the effects of the multiple paths in the space 200 on the transmitted signal, the space 200 may be represented as a transfer function (e.g., a filter) in which the transmitted signal is input and the received signal is output. When an object moves in the space 200, the attenuation or phase offset applied to a wireless signal along a signal path can change, and hence, the transfer function of the space 200 can change. When the same wireless signal is transmitted from the first wireless communication device 204A, if the transfer function of the space 200 changes, the output of that transfer function, e.g., the received signal, can also change. A change in the received signal can be used to detect motion of an object. Conversely, in some cases, if the transfer function of the space does not change, the output of the transfer function—the received signal—may not change.

FIG. 2C is a diagram showing an example wireless sensing system operating to detect motion in a space 201. The example space 201 shown in FIG. 2C is a home that includes multiple distinct spatial regions or zones. In the example shown, the wireless motion detection system uses a multi-AP home network topology (e.g., mesh network or a Self-Organizing-Network (SON)), which includes three access points (APs): a central access point 226 and two extension access points 228A, 228B. In a typical multi-AP home network, each AP typically supports multiple bands (2.4G, 5G, 6G), and multiple bands may be enabled at the same time. Each AP can use a different Wi-Fi channel to serve its clients, as this may allow for better spectrum efficiency.

In the example shown in FIG. 2C, the wireless communication network includes a central access point 226. In a multi-AP home Wi-Fi network, one AP may be denoted as the central AP. This selection, which is often managed by manufacturer software running on each AP, is typically the AP that has a wired Internet connection 236. The other APs 228A, 228B connect to the central AP 226 wirelessly, through respective wireless backhaul connections 230A, 230B. The central AP 226 may select a wireless channel different from the extension APs to serve its connected clients.

In the example shown in FIG. 2C, the extension APs 228A, 228B extend the range of the central AP 226, by allowing devices to connect to a potentially closer AP or different channel. The end user need not be aware of which AP the device has connected to, as all services and connectivity would generally be identical. In addition to serving all connected clients, the extension APs 228A, 228B connect to the central AP 226 using the wireless backhaul connections 230A, 230B to move network traffic between other APs and provide a gateway to the Internet. Each extension AP 228A, 228B may select a different channel to serve its connected clients.

In the example shown in FIG. 2C, client devices (e.g., Wi-Fi client devices) 232A, 232B, 232C, 232D, 232E, 232F, 232G are associated with either the central AP 226 or one of the extension APs 228 using a respective wireless link 234A, 234B, 234C, 234D, 234E, 234F, 234G. The client devices 232 that connect to the multi-AP executed on one or more of the client devices nodes in the multi-AP network. In some implementations, the client devices 232 may include wireless-enabled devices (e.g., mobile devices, a smartphone, a smart watch, a tablet, a laptop computer, a smart thermostat, a wireless-enabled camera, a smart TV, a wireless-enabled speaker, a wireless-enabled power socket, etc.).

When the client devices 232 seek to connect to, and associate with, their respective APs 226, 228, the client devices 232 may go through an authentication and association phase with their respective APs 226, 228. Among other things, the association phase assigns address information (e.g., an association ID or another type of unique identifier) to each of the client devices 232. For example, within the IEEE 802.11 family of standards for Wi-Fi, each of the client devices 232 can identify itself using a unique address (e.g., a 48-bit address, an example being the MAC address), although the client devices 232 may be identified using other types of identifiers embedded within one or more fields of a message. The address information (e.g., MAC address or another type of unique identifier) can be either hardcoded and fixed, or randomly generated according to the network address rules at the start of the association process. Once the client devices 232 have associated to their respective APs 226, 228, their respective address information may remain fixed. Subsequently, a transmission by the APs 226, 228 or the client devices 232 typically includes the address information (e.g., MAC address) of the transmitting wireless device and the address information (e.g., MAC address) of the receiving device.

In the example shown in FIG. 2C, the wireless backhaul connections 230A, 230B carry data between the APs and may also be used for motion detection. Each of the wireless backhaul channels (or frequency bands) may be different than the channels (or frequency bands) used for serving the connected Wi-Fi devices.

In the example shown in FIG. 2C, wireless links 234A, 234B, 234C, 234D, 234E, 234F, 234G may include a frequency channel used by the client devices 232A, 232B, 232C, 232D, 232E, 232F, 232G to communicate with their respective APs 226, 228. Each AP can select its own channel independently to serve their respective client devices, and the wireless links 234 may be used for data communications as well as motion detection.

The motion detection system, which may include one or more motion detection or localization processes running on one or more of the client devices 232 or on one or more of the APs 226, 228, may collect and process data (e.g., channel information) corresponding to local links that are participating in the operation of the wireless sensing system. The motion detection system can be installed as a software or firmware application on the client devices 232 or on the APs 226, 228, or may be part of the operating systems of the client devices 232 or the APs 226, 228.

In some implementations, the APs 226, 228 do not contain motion detection software and are not otherwise configured to perform motion detection in the space 201. Instead, in such implementations, the operations of the motion detection system are executed on one or more of the client devices 232. In other implementations, one or more operations of the motion detection system may be executed on a cloud-based processor. In some implementations, the channel information may be obtained by the client devices 232 by receiving wireless signals from the APs 226, 228 (or possibly from other client devices 232) and processing the wireless signal to obtain the channel information. For example, the motion detection system running on the client devices 232 can have access to channel information provided by the client device's radio firmware (e.g., Wi-Fi radio firmware) so that channel information may be collected and processed.

In some implementations, the client devices 232 send a request to their corresponding AP 226, 228 to transmit wireless signals that can be used by the client device as motion probes to detect motion of objects in the space 201. The request sent to the corresponding AP 226, 228 may be a null data packet frame, a beamforming request, a ping, standard data traffic, or a combination thereof. In some implementations, the client devices 232 are stationary while performing motion detection in the space 201. In other examples, one or more of the client devices 232 can be mobile and may move within the space 201 while performing motion detection.

Mathematically, a signal f(t) transmitted from a wireless communication device (e.g., the wireless communication device 204A in FIGS. 2A and 2B or the APs 226, 228 in FIG. 2C) may be described according to Equation (1):

$$f ( t ) = {\sum }_{n = - ∞}^{∞} {c}_{n} {e}^{j {ω}_{{n}^{t}}} \qquad ( 1 )$$

where ωₙ represents the frequency of n^{th} frequency component of the transmitted signal, cₙ represents the complex coefficient of the n^{th} frequency component, and t represents time. With the transmitted signal f(t) being transmitted, an output signal rₖ(t) from a path k may be described according to Equation (2):

$${r}_{k} ( t ) = {\sum }_{n = - ∞}^{∞} {α}_{n , k} {c}_{n} {e}^{j ( {ω}_{n} t + {ϕ}_{n , k} )} \qquad ( 2 )$$

where α_{n,k} represents an attenuation factor (or channel response; e.g., due to scattering, reflection, and path losses) for the n^{th} frequency component along path k, and ϕ_{n,k} represents the phase of the signal for n^{th} frequency component along path k. Then, the received signal R at a wireless communication device can be described as the summation of all output signals rₖ(t) from all paths to the wireless communication device, which is shown in Equation (3):

$$R = {\sum }_{k} {r}_{k} ( t ) \qquad ( 3 )$$

Substituting Equation (2) into Equation (3) renders the following Equation (4):

$$R = {\sum }_{k} {\sum }_{n = - ∞}^{∞} ( {α}_{n , k} {e}^{j {ϕ}_{n , k}} ) {c}_{n} {e}^{j {ω}_{{n}^{t}}} \qquad ( 4 )$$

The received signal R at a wireless communication device (e.g., the wireless communication devices 204B, 204C in FIGS. 2A and 2B or the client devices 232 or the APs 226, 228 in FIG. 2C) can then be analyzed (e.g., using one or more motion detection algorithms) to detect motion. The received signal R at a wireless communication device can be transformed to the frequency domain, for example, using a Fast Fourier Transform (FFT) or another type of algorithm. The transformed signal can represent the received signal R as a series of n complex values, one for each of the respective frequency components (at the n frequencies ωₙ). For a frequency component at frequency ωₙ, a complex value Yₙ may be represented as follows in Equation (5):

$${Y}_{n} = {\sum }_{k} {c}_{n} {α}_{n , k} {e}^{j {ϕ}_{n , k}} . \qquad ( 5 )$$

The complex value Yₙ for a given frequency component ωₙ indicates a relative magnitude and phase offset of the received signal at that frequency component ωₙ. The signal f(t) may be repeatedly transmitted within a time period, and the complex value Yₙ can be obtained for each transmitted signal f(t). When an object moves in the space, the complex value Yₙ changes over the time period due to the channel response α_{n,k} of the space changing. Accordingly, a change detected in the channel response (and thus, the complex value Yₙ) can be indicative of motion of an object within the communication channel or relative motion of a transmitter or receiver. Conversely, a stable channel response may indicate lack of motion. Thus, in some implementations, the complex values Yₙ for each of multiple devices in a wireless network can be processed to detect whether motion has occurred in a space traversed by the transmitted signals f(t). The channel response can be expressed in either the time-domain or frequency-domain, and the Fourier-Transform or Inverse-Fourier-Transform can be used to switch between the time-domain expression of the channel response and the frequency-domain expression of the channel response.

In another aspect of FIGS. 2A, 2B, 2C, beamforming state information may be used to detect whether motion has occurred in a space traversed by the transmitted signals f(t). For example, beamforming may be performed between devices based on some knowledge of the communication channel (e.g., through feedback properties generated by a receiver), which can be used to generate one or more steering properties (e.g., a steering matrix) that are applied by a transmitter device to shape the transmitted beam/signal in a particular direction or directions. In some instances, changes to the steering or feedback properties used in the beamforming process indicate changes, which may be caused by moving objects in the space accessed by the wireless signals. For example, motion may be detected by identifying substantial changes in the communication channel, e.g., as indicated by a channel response, steering or feedback properties, or any combination thereof, over a period of time.

In some implementations, for example, a steering matrix may be generated at a transmitter device (beamformer) based on a feedback matrix provided by a receiver device (beamformer) based on channel sounding. Because the steering and feedback matrices are related to propagation characteristics of the channel, these beamforming matrices change as objects move within the channel. Changes in the channel characteristics are accordingly reflected in these matrices, and by analyzing the matrices, motion can be detected, and different characteristics of the detected motion can be determined. In some implementations, a spatial map may be generated based on one or more beamforming matrices. The spatial map may indicate a general direction of an object in a space relative to a wireless communication device. In some cases, “modes” of a beamforming matrix (e.g., a feedback matrix or steering matrix) can be used to generate the spatial map. The spatial map may be used to detect the presence of motion in the space or to detect a location of the detected motion.

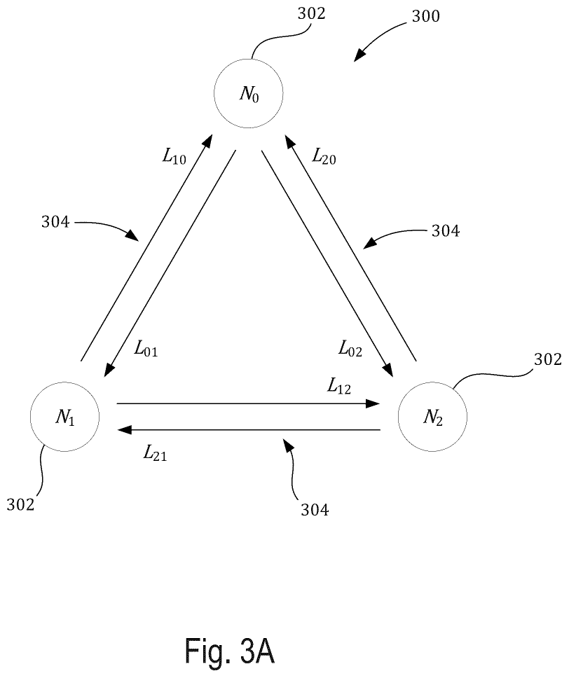

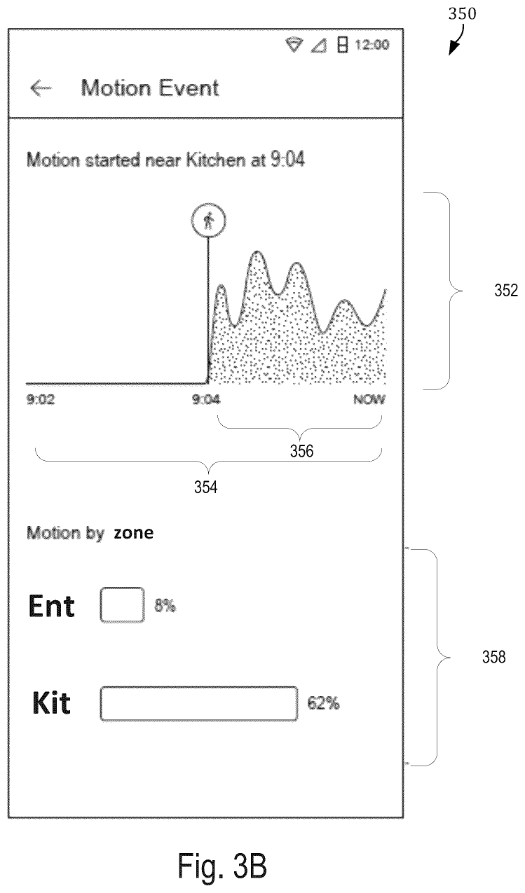

FIG. 3A is a schematic diagram of an example wireless communication network 300 that includes a plurality of wireless nodes 302. The plurality of wireless nodes 302 may be analogous to the wireless communication devices 102, 204 of FIGS. 1 and 2A-2B, respectively. In FIG. 3A, three wireless nodes 302 are depicted, labeled N₀, N₁, and N₂. However, other numbers of wireless nodes 302 are possible in the wireless communication network 300. Moreover, other types of nodes are possible. For example, the wireless communication network 300 may include one or more network servers, network routers, network switches, network repeaters, or other types of networking or computing equipment.

The wireless communication network 300 includes wireless communication channels 304 communicatively coupling respective pairs of wireless nodes 302. Such communicative coupling may allow an exchange of wireless signals between wireless nodes 302 over a time frame. In particular, the wireless communication channels 304 allow bi-directional communication between the respective pairs of wireless nodes 302. Such communication may occur along two directions simultaneously (e.g., full duplex) or along only one direction at a time (e.g., half duplex). In some instances, such as shown in FIG. 3A, the wireless communication channels 304 communicatively couple every pair of the plurality of wireless nodes 302. In other instances, one or more pairs of wireless nodes 302 may lack a corresponding wireless communication channel 304.

Each wireless communication channel 304 includes two or more wireless links, including at least one for each direction in the bi-directional communication. In FIG. 3A, an arrow represents each individual wireless link. The arrow is labeled Lᵢⱼ where a first subscript, i, indicates a transmitting wireless node and a second subscript, j, indicates a receiving wireless node. For example, wireless nodes N₀ and N₁ are communicatively coupled by two wireless links that are indicated in FIG. 3A by two arrows, L₀₁ and L₁₀. Wireless link L₀₁ corresponds to wireless communication along a first direction from N₀ to N₁ and wireless link L₁₀ corresponds wireless communication along a second, opposing direction from N₁ to N₀.

In some implementations, the wireless communication network 300 obtains a set of motion indicator values associated with a time frame, which may include the processes of motion detection described in relation to FIGS. 2A-2B. The set of motion indicator values indicate motion detected from wireless links in a wireless communication network. Each motion indicator value is associated with a respective wireless link. The motion may be detected using one or more wireless links (e.g., one or more wireless links L₀₁, L₁₀, L₀₂, L₂₀, L₁₂, and L₂₁ of FIG. 3A) in the wireless communication network (e.g., the wireless communication network 300). Each of the wireless links is defined between a respective pair of wireless communication devices in the wireless communication network (e.g., pair combinations of wireless nodes N₀, N₁, and N₂).

In some variations, the wireless communication network 300 may include a data processing apparatus that executes program instructions (e.g., a network server, a wireless communication device, a network router, etc.). The program instructions may cause the data processing apparatus to assign a unique node identifier to each of the wireless nodes 302 in the wireless communication network 300. The unique node identifier may be mapped to a media access control (MAC) address value, which corresponds to a MAC address (or portion thereof) associated with a wireless node. For example, the wireless nodes N₀, N₁, and N₂ of FIG. 3A may be associated with a six-character portion of their respective MAC addresses, which is then mapped to a unique node identifier:
{N₀,N₁,N₂}→{7f4440, 7f4c9e, 7f630c}→{0,1,2}
   Here, the MAC address values of 7f4440, 7f4c9e, and 7f630c are mapped to respective unique node identifiers 0, 1, and 2. The program instructions may also cause the data processing apparatus to associate the wireless links with their respective pairs of wireless nodes via corresponding pairs of MAC address values. The MAC address values may then be mapped to a unique link identifier to form a link table. For example, the wireless links L₀₁, L₁₀, L₀₂, L₂₀, L₁₂, and L₂₁ of FIG. 3A may be mapped to unique link identifiers according to:

$$\{ \begin{matrix}{L}_{01} \\ {L}_{02} \\ {L}_{10} \\ {L}_{12} \\ {L}_{20} \\ {L}_{21}\end{matrix} \} \to \{ \begin{matrix}7 f 4440 \to 7 f 4 c 9 e \\ 7 f 4440 \to 7 f 630 c \\ 7 f 4 c 9 e \to 7 f 4440 \\ 7 f 4 c 9 e \to 7 f 630 c \\ 7 f 630 c \to 7 f 4440 \\ 7 f 630 c \to 7 f 4 c 9 e\end{matrix} \} \to \{ \begin{matrix}0 \\ 1 \\ 2 \\ 3 \\ 4 \\ 5\end{matrix} \}$$

The MAC address values may be ordered, from left to right, to indicate respective pairs of transmitting and receiving wireless nodes in a wireless link. In particular, the left MAC address value may correspond to a transmitting wireless node and the right MAC address value may correspond to a receiving wireless node. Such mappings of unique node and link identifiers may aid the data processing apparatus in performing operations, such as searching, sorting, and matrix manipulation, during processes of motion detection.

The program instructions may additionally cause the data processing apparatus to poll the wireless links (or wireless nodes 302) to obtain motion indicator values for each wireless link in the plurality of wireless links. For example, the wireless links of the wireless communication network 300 of FIG. 3A may report motion indicator values according to a data structure, such as shown below:

$$\{ \begin{matrix}0 & 0.00 \\ 1 & 0.00 \\ 2 & 0.71 \\ 3 & 1.07 \\ 4 & 1.15 \\ 5 & 1.3\end{matrix} \}$$

In the data structure, the first column corresponds to the unique link identifiers of the wireless links and the second column of the data structure corresponds to their respective motion indicator values. Generally, a higher motion indicator value is indicative of a higher degree of perturbation of a particular wireless link. The data structure may be an array, as shown above, or some other type of data structure (e.g., a vector). Although data structure is presented as having three significant digits for each motion indicator value, other numbers of significant digits are possible for the motion indicator values (e.g., 2, 5, 9, etc.).

In some implementations, the output of the motion detection system may be provided as a notification for graphical display on a user interface on a user device. FIG. 3B is a diagram showing an example graphical display on a user interface 350 on a user device. In some implementations, the user device is the client device 232 used to detect motion, a user device of a caregiver or emergency contact designated to an individual in the space 200, 201, or any other user device that is communicatively coupled to the motion detection system to receive notifications from the motion detection system.

The example user interface 350 shown in FIG. 3B includes an element 352 that displays motion data generated by the motion detection system. As shown in FIG. 3B, the element 352 includes a horizontal timeline that includes a time period 354 (including a series of time points 356) and a plot of motion data indicating a degree of motion detected by the motion detection system for each time point in the series of time points 356. In the example shown, the user is notified that the detected motion started near a particular location (e.g., the kitchen) at a particular time (e.g., 9:04), and the relative degree of motion detected is indicated by the height of the curve at each time point.

The example user interface 350 shown in FIG. 3B also includes an element 358 that displays the relative degree of motion detected in each motion zone of the motion detection system. In particular, the element 358 indicates that 8% of the motion was detected in the “Entrance” zone while 62% of the motion was detected in the “Kitchen” zone. The data provided in the elements 352, 358 can help the user determine an appropriate action to take in response to the motion detection event, correlate the motion detection event with the user's observation or knowledge, determine whether the motion detection event was true or false, and so forth.

In some implementations, the output of the motion detection system may be provided in real-time (e.g., to an end user). Additionally, or alternatively, the output of the motion detection system may be stored (e.g., locally on the wireless communication devices 204, client devices 232, the APs 226, 228, or on a cloud-based storage service) and analyzed to reveal statistical information over a time frame (e.g., hours, days, or months). An example where the output of the motion detection system may be stored and analyzed to reveal statistical information over a time frame is in health monitoring, vital sign monitoring, sleep monitoring, etc. In some implementations, an alert (e.g., a notification, an audio alert, or a video alert) may be provided based on the output of the motion detection system. For example, a motion detection event may be communicated to another device or system (e.g., a security system or a control center), a designated caregiver, or a designated emergency contact based on the output of the motion detection system.

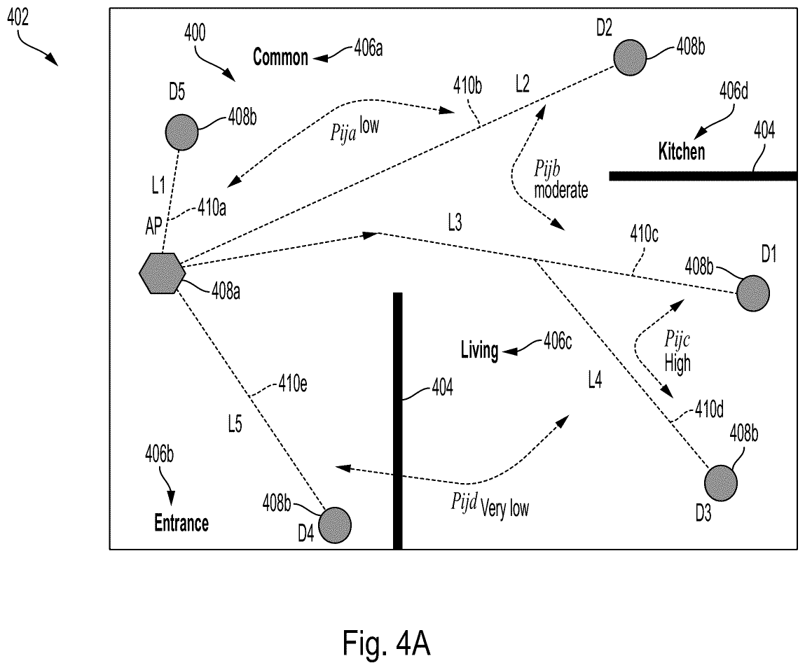

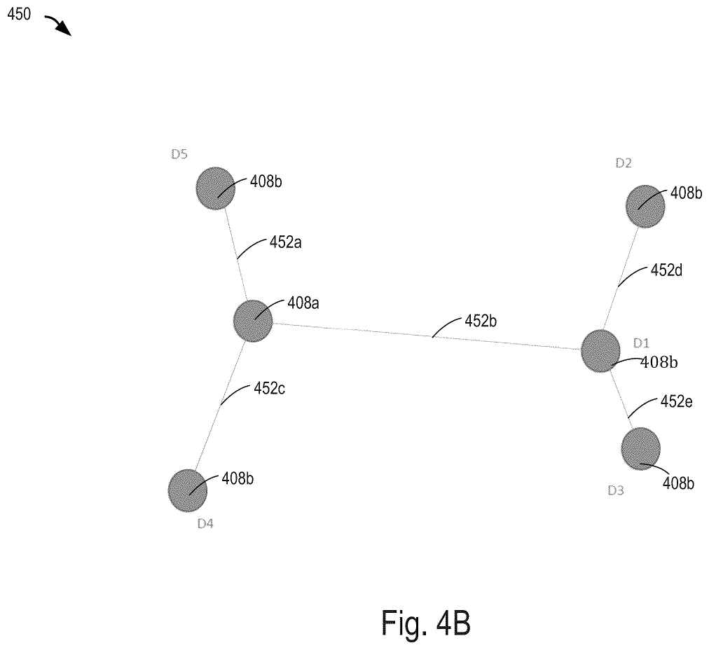

Now referring to FIG. 4A, a diagram is presented of an example space 400 associated with a wireless communication network 402. The example space 400 may be a residence partitioned by one or more physical walls 404 to define various regions 406 such as a common area 406a, an entrance 406b, a living room 406c, a kitchen 406d, and so forth. The wireless communication network 402 includes wireless communication devices 408a, 408b connected by wireless links 410. For example, wireless link 410a connects the AP 408a with wireless communication device D5 (408b). Wireless link 410b connects the AP 408a with the wireless communication device D2 (408b). Wireless link 410c connects the AP 408a with the wireless communication device D1 (408b). Wireless link 410d connects the AP 408a with the wireless communication device D3 (408b). Wireless link 410e connects the AP 408a with the wireless communication device D4 (408b). In FIG. 4A, the wireless communication devices 408a, 408b are labeled Di where the index i indicates the ith wireless communication device. Similarly, the wireless links 410 are labeled by Li where the index i indicates the ith wireless link 410. The wireless communication devices in FIG. 4A include wireless AP devices 408a, which can serve as a hub in the wireless communication network 402, and wireless client (or leaf) devices 408b, such as a mobile device, a smartphone, a smart watch, a tablet, a laptop computer, a smart thermostat, a wireless-enabled camera, a smart TV, a wireless-enabled speaker, a wireless-enabled power socket, and so forth. The wireless links 410 may be defined by respective pairs of wireless communication devices in the wireless communication network 402. The wireless communication network 402 may be part or all of a motion detection system that, in many variations, generates motion-sensing data based on wireless signals transmitted over the wireless links 410.

In certain cases, the example space 400 may include an object or person that moves therein. The motion of such an object or person may disturb the wireless links 410, and in particular, pairs of wireless links 410 adjacent each other. A probability—shown as pᵢⱼ in FIG. 4A—may be associated with pairs of wireless links that are sequentially disturbed by motion in time. For example, the probability pᵢⱼ(a) is associated with the wireless links L1 and L2. The probability pᵢⱼ(b) is associated with the wireless links L2 and L3. The probability pᵢⱼ(c) is associated with the wireless links L3 and L4. The probability pᵢⱼ(d) is associated with the wireless links L4 and L5. This probability may scale inversely in magnitude with a distance between wireless communication devices 408a, 408b defining the pair of wireless links. For example, the probability may scale inversely with a distance between a first wireless communication device associated with a first of the pair of wireless links and a second wireless communication device associated with a second of the pair of wireless links disturbed by the motion. The pair of wireless links may share a wireless communication device in common (e.g., a wireless AP 408a). FIG. 4A depicts the pair of wireless links associated with respective wireless clients 408b. However, other types of wireless communication devices are possible (e.g., APs).

The probability of sequential disturbance may be influenced by factors in the example space 400, such as a relative location of wireless communication devices defining the pair of wireless links and physical objects (e.g., the one or more physical walls 404) therebetween. A probability of sequential disturbance is the probability of exciting one particular set of links, right after another particular set of links. For example, wireless communication devices that are close to each other, such as wireless communication devices D1 and D3, may define a pair of wireless links (e.g., L3 and L4) that have a higher probability of sequential disturbance than a pair of wireless links (e.g., L1 and L2) defined by wireless communication devices that are farther away from each other, such as wireless communication devices D2 and D5. The presence of a physical wall 404 may impede motion of the object or person and thus reduce a transition of the object or person from one side of the physical wall 404 to the other. For example, the pair of wireless links L2 and L3 in the example space 400 are separated by a physical wall 404, and as such, the probability of their sequential disturbance may be reduced relative to situations where the physical wall 404 is absent. The interval over which this integration happens is a design parameter. A typically-suggested interval for determining these transition probabilities is that of one day (24 hours) which allows (but not always) that user has visited all the locations associated with different wireless devices, and has disturbed all the links at least once, for the system to have estimated these sequential or transition probabilities.

In some implementations, the example space 400 corresponds to a house partitioned into different living spaces. The entrance 406b and the living room 406c may have a large wall separating them, so a person entering the entrance 406b will not be able to go into the living room 406c without passing through the common area 406a where the wireless AP 408a is located. Because the person is unable to traverse directly between the entrance 406b and the living room 406c, the motion-sensing data will represent a low probability of transitions between the entrance and living room footprints of the wireless links 410 (e.g., between L4 and L5). As such, the motion-sensing data may provide a basis for a map of the house that places the entrance 406b and living room 406c away from each other. Moreover, the kitchen 406d is on a corner of the house opposite the entrance 406b. Motion between the entrance 406b to the kitchen 406d is even less likely than motion between the entrance 406b and the living room 406c. As such, the motion-sensing data will represent (if at all) a very low probability of transitions between the entrance and kitchen footprints of the wireless links 410 (e.g., between L2 and L5). In this case, the motion-sensing data may provide a basis for a map of the house that places the entrance 406b and kitchen 406d farther away from each other than the entrance 406b and living room 406c. However, the kitchen 406d and the living room 406c are separated by a partial wall. Such a configuration may be analogous to an “open concept” house and thus motion between the kitchen 406d and the living room 406c may be common. The motion-sensing data will therefore represent a high probability of transitions between the kitchen and living room footprints of the wireless links 410 (e.g., L2 and L3). The motion-sensing data may therefore provide a basis for a map of the house that places the kitchen 406d and the living room 406c close to each other (e.g., adjacent each other).

As shown in FIG. 4A, different living spaces of the house may be associated with one or more wireless communication devices. The common area 406a, the entrance 406b, and the kitchen 406d are associated with, for example, respective wireless communication devices D5, D4, and D2. The living room 406c is associated with two wireless communication devices D1 and D3. In some instances, the one or more wireless communication devices allow the sequential disturbance of two wireless links 410 to be related to motion of an object or person between different living spaces. For example, the sequential disturbance of wireless links L2 and L3 may be related to motion between the living room 406c and the kitchen 406d. In some instances, the one or more wireless communication devices allow the sequential disturbance of two wireless links 410 to be related to motion within a single living space. For example, the sequential disturbance of wireless links L3 and L4 may be related to motion within the living room 406c.

As discussed above, the probability of disturbing a pair of wireless links 410 in the house can be related to a distance between two wireless communication devices associated with the pair of wireless links 410. For example, wireless communication devices D1 and D3 are closer to each other than wireless communication devices D2 and D5. As such, the probability of wireless links L3 and L4 being sequentially disturbed is higher than the probability of wireless links L1 and L2 being sequentially disturbed. Motion-sensing data for the house may therefore indicate a high frequency of disturbance for wireless links L3 and L4 relative to wireless links L1 and L2. This motion-sensing data may thus be used to determine the probabilities for the sequential disturbance of wireless links L3 and L4 relative to wireless links L1 and L2. The probabilities, in turn, allow for the distance between wireless communication devices D1 and D3 and the distance between wireless communication devices D2 and D5 to be determined. In general, motion-sensing data for pairs of wireless links 410 in the house may be used to determine distances between pairs of wireless communication devices, which in turn, can be used to determine a spatial map for the wireless communication devices.

FIG. 4B is a diagram of an example spatial map 450 based on the example space 400 of FIG. 4A. The example spatial map 450 represents a spatial arrangement of the wireless communication devices 408a, 408b in the example space 400. The spatial arrangement may be based on spatial coordinates (e.g., x-y coordinates) for each of the wireless communication devices 408a, 408b in a coordinate system of the example spatial map 450, and the spatial coordinates may be generated based on the motion-sensing data. In some instances, the coordinate system is a physical coordinate system (e.g., using physical coordinates). In other instances, the coordinate system is a logical coordinate system (e.g., using arbitrary coordinates). To generate the spatial coordinates, a computing device may process the motion-sensing data to determine distances between pairs of wireless communication devices 408a, 408b, and from the distances, calculate the spatial coordinates. In many implementations, the spatial arrangement of the wireless communication devices includes spatial paths 452 between select pairs of wireless communication devices. For example, spatial path 452a is between the AP (408a) and the wireless communication device D5 (408b). Spatial path 452b is between the AP (480a) and the wireless communication device D1 (408b). Spatial path 452c is between the AP (408a) and the wireless communication device D4 (408b). Spatial path 452d is between the wireless communication device D1 (408b) and the wireless communication device D2 (408b). Spatial path 452e is between the wireless communication device D1 (408b) and the wireless communication device D3 (408b). The computing device may determine the spatial paths 452 by generating a spanning tree from the spatial coordinates. For example, the computing device may execute a spanning tree algorithm to determine a minimum number of spatial paths 452 to connect the wireless communication devices 408. In some instances, the minimum number corresponds to a number of spatial paths 452 with respective lengths that, when summed, have a minimum length. The connectivity illustrated by way of example in FIG. 4B refers to the connectivity of a spanning tree. The spanning tree is based on the distances between devices. Thus, the lines in FIG. 4B do not represent a wireless link. But rather a spanning tree link.

In some implementations, a computing device determines the spatial coordinates by generating a final set of spatial coordinates from an initial set of spatial coordinates. For example, the computing device may execute program instructions that define an optimization process for the initial set of spatial coordinates. In these implementations, the computing device may produce a first data structure (e.g., a first matrix) from the motion-sensing data that includes a probability value for each pair of wireless links 410. The probability value may represent a probability of the pair of wireless links 410 being sequentially disturbed. The computing device also produces a second data structure (e.g., a second matrix) that includes a distance value for each pair of wireless communication devices defining a wireless link 410. The distance value may be based on a probability value (e.g., a reciprocal thereof) and represents a distance between the pair of wireless communication devices. For instance, the distance dᵢⱼ between two devices may be related to the probability pᵢⱼ associated with the two devices as dᵢⱼ∝1/pᵢⱼ or otherwise. The computing device then converts the distance values into the initial set of spatial coordinates. The initial set of spatial coordinates indicates the locations of the wireless communication devices in a two-dimensional coordinate system (e.g., an x-y coordinate system). The two-dimensional coordinate system may be a physical or logical coordinate system. In some instances, the computing device produces a third data structure (e.g., a third matrix) that includes the initial set of spatial coordinates.

In implementations using the optimization process, the computing device then selects arbitrary coordinates for a pair of wireless communication devices that define a wireless link 410. The computing device subsequently determines, based on the arbitrary coordinates, a test distance between the pair of wireless communication devices. This test distance is subtracted from a distance value for the pair of wireless communication devices in the second data structure. The resulting difference is then squared. For example, and with reference to FIG. 4A, the second data structure may have a distance value, dₚ¹², representing a distance between wireless communication devices D1 and D2. The distance value, dₚ¹², is based on a probability, p₂₃, of wireless links L2 and L3 being sequentially disturbed. The computing device selects arbitrary coordinates, represented by vector x, for wireless communication devices D1 and D2 in the two-dimensional coordinate system. Based on these coordinates, the computing device determines a test distance, dₓ¹², for wireless communication devices D1 and D2 and subtracts the distance value, dₚ¹², from the test distance. The difference is subsequently squared, e.g., (dₓ¹²−dₚ¹²)².

As part of the optimization process, the computing device determines a squared difference for each pair of wireless communication devices defining a wireless link 410 (e.g., as described above). The computing device then sums all of the squared differences to produce a residual value that characterizes the arbitrary coordinates selected for the pairs of wireless communication devices. The computing device subsequently alters the arbitrary coordinates in iterative fashion to find a minimum residual value. The arbitrary coordinates associated with the minimum residual value correspond to the final set of spatial coordinates and may be aggregated into a third data structure (e.g., a third matrix). In some cases, the optimization process can use the objective:

$$X = {argmin}_{x} \sum {( D ( X ) - {D}_{p} )}^{2}$$

where X is a vector of coordinates for each device; D(X) is a distance matrix generator from coordinates, and Dₚ is a distance matrix generator from inverse probabilities.

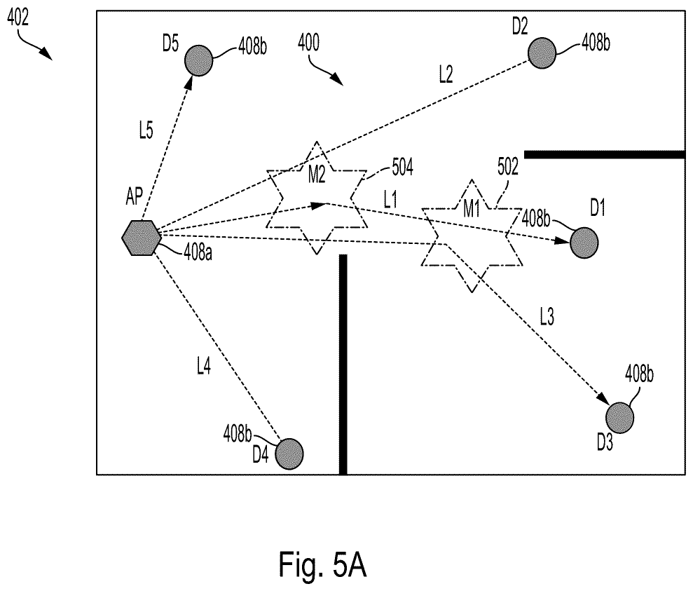

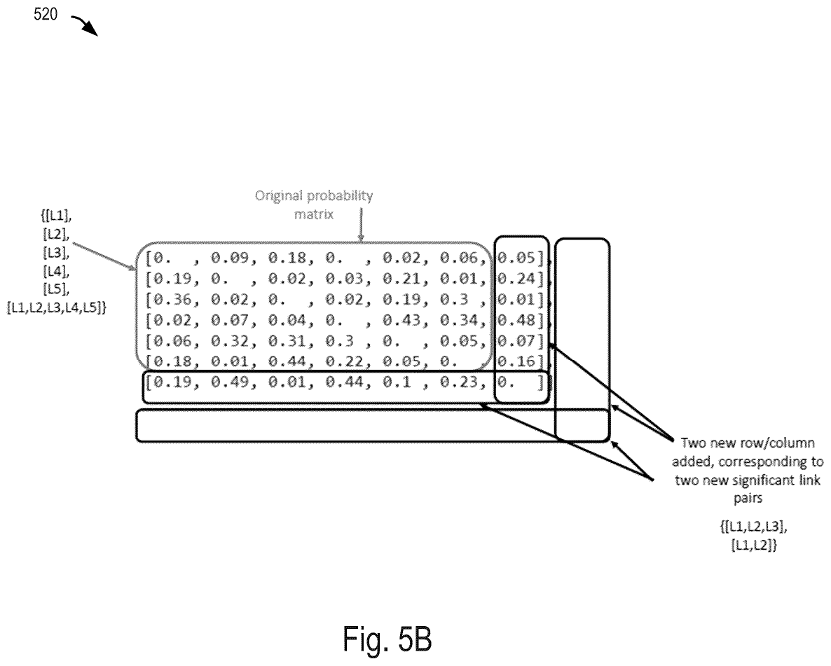

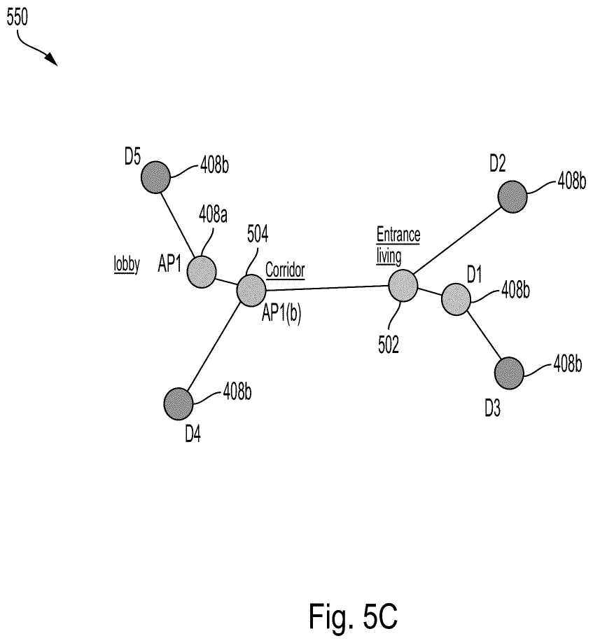

FIG. 5A is a diagram of the example space 400, illustrated in FIG. 4A. A motion detection system may initially identify motion zones associated with each of the wireless communication devices 408a, 408b. Typically, motion in one of the zones associated with a wireless communication device will disturb all the wireless links of that device. For example, motion at the AP in FIG. 5A will typically disturb wireless links L1, L2, L3, L4, and L5; and motion at each of the leaf devices will typically disturb that leaf device's sole wireless link. In some cases, the motion detection system can identify one or more new motion zones that are not associated with any of the wireless communication devices. In the example shown in FIG. 5A, a first region 502 and a second region 504 are identified in the space 400 based on motion-sensing data derived from wireless signals transmitted through the space 400. The first region 502 and the second region 504 are not associated with any of the wireless communication devices 408a, 408b. The first region 502 is an area in the space 400 where the wireless link L1 and the wireless link L3 are concurrently affected by motion. In this example, the concurrent excitation of the wireless link L1 and the wireless link L3, represented by the link disturbance signature [L1, L3] indicates there is a region in the space 400 that is distinct from regions that are close in proximity to device D1, or device D3. Hence the first region 502 can be represented as a distinct physical area, and can be labeled (e.g., in collaboration with the user). The second region 504 is defined by the concurrent excitation of three wireless links in the space 400. In the case of the second region 504, represented by the link disturbance signature [L1, L2, L3], wireless link L3, wireless link L1, and wireless link L2 are concurrently disturbed. When regions such as, for example, the first region 502 and the second region 504 are discovered, the system can then present the new information to the user (e.g., in the form of a graphical representation of the space), to obtain an appropriate name/label for the region 502 and the region 504 in the space 400. In various embodiments, other characteristics of motion-sensing data and wireless link disturbances (besides co-excitation of link with other links) can be analyzed to discover new motion zones such as, for example, the region 502 and the region 504.

FIG. 5B is an example of a transition matrix 520 illustrating the addition of motion zones that are not associated with a wireless communication device. The transition matrix 520 shows the probability of motion transitions between pairs of the motion zones. If there are many transitions between the two motion zones then that can be interpreted as a proxy for physical proximity, and the inverse of the transition probability can be used as a measure of distance between the motion zones as discussed above.

In this case however, rows and columns are added to the matrix to represent new motion zones. In this example, the new motion zones are the regions 502, 504 that have the link disturbance signatures discussed above with respect to FIG. 5A. In particular, a first new row and a first new column are added to the transition matrix 520 to represent a first new motion zone, which is the region 502 that has the link disturbance signature [L1, L3]; a second new row and a second new column are added to the transition matrix 520 to represent a second new motion zone, which is the region 504 that has the link disturbance signature [L1, L2, L3]. The added rows contain a transition number to and from the additional signatures that have been discovered in the space and are not associated with a wireless communication device. In the example illustrated in FIG. 5A, two new motion zones were described. Thus, two rows and two columns are added to the transition matrix. The rows and columns are again, the transition numbers to and from, the newly-determined motion zones corresponding to, for example, the first region 502 and the second region 504. Once the matrix is constructed, the distance matrix can be decomposed into coordinates, such that the coordinates satisfy the distance between any two points as given in the matrix.

FIG. 5C is an example spatial map 550 based on the space 400 as illustrated in FIG. 5A illustrating locations of the first region 502 and the second region 504 of significant link-disturbance signatures. The spatial map 550 shows the result of adding two extra rows and columns to the matrix illustrated in FIG. 5B. As shown in FIG. 5C, the two new motion zones are represented as new points in the spatial map 550. In particular, the “entrance living” point in the spatial map 550 corresponds to region 502 in FIG. 5A, and the “corridor” point in the spatial map 550 corresponds to region 504 in FIG. 5A. The connectivity illustrated by way of example in FIG. 5C refers to the connectivity of a spanning tree. The spanning tree is based on the distances between devices. Thus, the lines in FIG. 5C do not represent a wireless link. But rather a spanning tree link.

Referring again to FIG. 5A, in moving from the access point AP to the device D1, a unique link disturbance pattern is created in the second region 504. In FIG. 5C, this link-disturbance pattern has now been plotted as a new motion zone on the spatial map 550 for the user. Additionally, the user may receive a notification that, somewhere between the access point AP and the device D1, the system has discovered a new zone. The system may inquire if the user would like to label this new zone. If the user would like to label the new zone, a name can be assigned to this pattern (“Corridor” for example). This process may be repeated for all such new motion zones based on the discovered link disturbance patterns. Thus, once a new motion zone is discovered, and shown to the user, the user may be presented with two (or more) basic choices. First, the user may recognize the new motion zone as a new unique zone in the house, or, second, the user might not be interested in that level of granularity and decide to not name the newly-identified motion zone.

Still referring to FIG. 5B, the functionality of allowing the user to decide to label the newly-identified motion zones has particular application in internet of things (IoT) applications, where the user may have a preference for how a certain space is utilized or controlled. For example, the user might want the light to turn on when the user is present in, for example, the lobby; or the user may want the light to stay on even when the user moves to, for example, the corridor. In this exemplary application, the lobby and corridor need not be differentiated as the user does not want to have separate control over the lobby and the corridor space. Thus, a new zone is not required. If, however, the user does want separate control over the two spaces, the user can choose to have two separate labels assigned to the individual spaces.

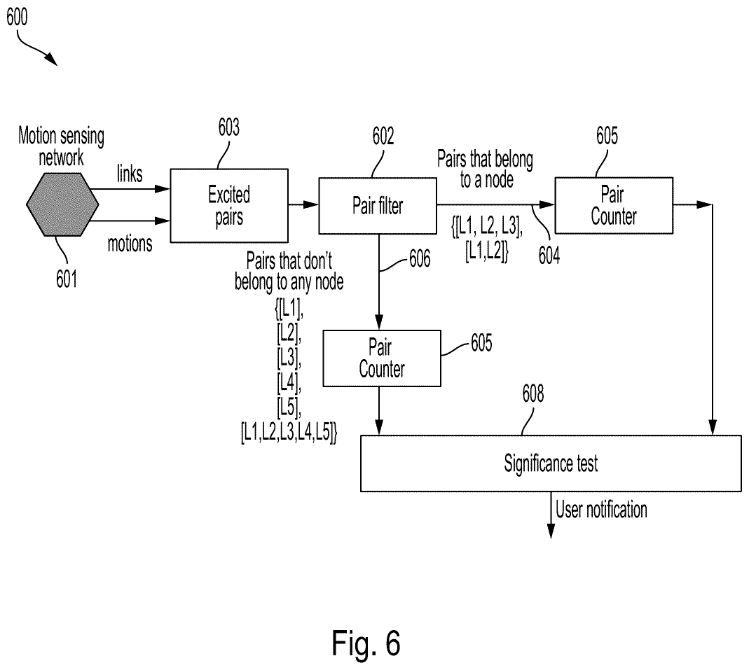

FIG. 6 is a block diagram of an example method of determining significance of link-disturbance signatures. In various embodiments, a unique zone can look like an excitation of a combination of wireless links, which would not normally experience concurrent disturbance. With respect to FIG. 6, the excited links are illustrated as block 603. However, just the occurrence of a unique link disturbance signature by itself is not sufficient as sometimes different excitations can be caused by other phenomena, for example, noise, or multiple people. For an unexpected link excitation signature to be considered unique and effectively present, it should also happen frequently enough, in relation to disturbances observed on other wireless links. Thus, the statistical significance of the link excitation signature can be measured by the relative frequency of the signature formed by a combination of links with respect to the constituent links. If the number of occurrences of the link excitation signature combination, as a fraction of the number of occurrences of individual links combined, is above a certain threshold, then the link excitation signature is persistent enough to be a device-less zone, and is robust enough, to be mapped within the space 400. For example, in various embodiments, if a certain link excitation signature is seen at least 1% of the time, amongst all possible link pairs, for two days in a row, then the link-excitation signature may be considered a robust and persistent link-excitation pattern.

Still referring to FIG. 6, link excitation on wireless network 601 is measured, and then split into two branches by a pair filter 602. The pair filter 602 splits the link pairs into two streams. In a first stream 604 are pairs that occur in the system by virtue of network connectivity. For example, the pattern {L1} and {L1, L2, L3, L4, L5} are network-induced (or “natural”) pairs. This means that the connectivity of the network ensures that these link pairs will be present. For example, if motion occurs close to device D1, the pair {L1} will be excited. However, if motion occurs near the AP, the pair {L1, L2, L3, L4, L5} will be excited. The pair filter 602 separates the pairs that are induced by network connectivity from those that are not induced by network connectivity. The links that arise due to network connectivity remain in the system, while non-connectivity induced links are subjected to a persistence test to be present in the system. In the first stream 604 are the links and link pairs, which are expected due to the topology of the network. Examples of those sets include [{L1}, {L2}, {L3}, {L4}, {L5}, {L1L2L3L4L5}]. In various embodiments, {L1L2L3L4L5} is a naturally occurring pair, because when movement occurs close to the access point (AP), the movement is disturbing all the links connected to the access point (AP). In the second stream 606, are signatures that are unexpected. Examples of those include those that have been discussed earlier such as, for example, [{L1L3}, {L1L2L3}]. Each of the links in the first stream 604 and the second stream 606 are then passed to a pair counter 605. The pair counters 605 count the link patterns seen in any given amount of time. For example, if the aggregation threshold is based on a twenty four hour period, then the counters will count every time a link pair occurs in the twenty four hour period. The system then runs the significance test on the counted link pairs. The pair counter then resets and start counting again. After counting by the pair counter 605, the newly-discovered signatures are analyzed via a statistical significance test 608. The significance test 608 measures that a certain unexpected (or “novel”) link pair that is seen consistently enough that it can be considered significant. In various implementations, the significance threshold is a design parameter that is configured by a user or designer. For example, a user may indicate that he visits certain areas of the space once per week. In such a scenario, any connected WiFi client will see motion in those certain areas for at least a few seconds every week. If a unique or novel link pair is consistently seen for at least a few seconds every week, such a novel link pair could be considered significant. Similarly, a user could also indicate that he visits other areas of the space every day. In this scenario, the significance test would change from a novel link-excitation signature being present for a few seconds every week to a novel link-excitation signature being present for a few seconds every twenty four hours. If the occurrence of signatures is frequent enough, the identified link disturbance signatures are added to a link dictionary of effective zones in the network.

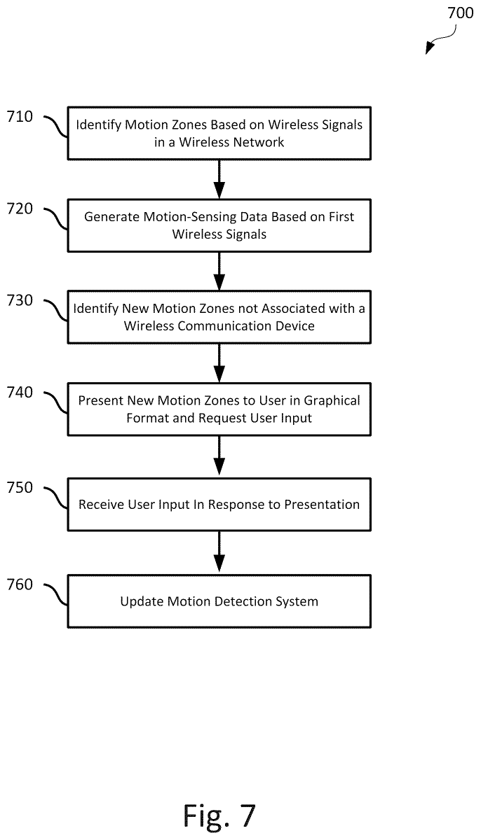

FIG. 7 is a flow diagram of an example process 700 performed, for example, by a motion detection system. The motion detection system can process information based on wireless signals transmitted (e.g., on wireless links between wireless communication devices) through a space to detect motion of objects in the space (e.g., as described with respect to FIGS. 1 and 2A-2B or otherwise). Operations of the example process 700 may be performed by a remote computer system (e.g., a server in the cloud), a wireless communication device (e.g., one or more of the wireless communication devices), or another type of system. For example, one or more operations in the example process 700 may be performed by one or more of the example wireless communication devices 102A, 102B, 102C in FIG. 1, client devices 232 or the Aps 226, 228 in FIG. 2C, the wireless communication devices 408a, 408b of FIG. 4A-4B, or by a cloud-based computer system.

The example process 700 may include additional or different operations, and the operations may be performed in the order shown or in another order. In some cases, one or more of the operations shown in FIG. 7 can be implemented as a process that includes multiple operations, sub-processes, or other types of routines. In some cases, operations can be combined, performed in another order, performed in parallel, iterated or otherwise repeated, or performed in another manner.

At 710, motion zones are identified. At least a subset (e.g., one, some or all) of the motion zones are associated with wireless communication devices in a wireless network. In some cases, one or more of the motion zones is not associated with a wireless communication device. Each motion zone represents a distinct region in a space where motion can be detected by the motion detection system. For example, the distinct region may, in various embodiments, be a space proximate to a wireless communication device associated with the wireless network.

At 720, motion sensing data is generated based on wireless signals transmitted between pairs of wireless communication devices in the wireless communication network. In various embodiments, the motion sensing data represents motion occurring in the space. For example, motion-sensing data may be generated based on first wireless signals transmitted, during a first time period, over wireless links defined by respective pairs of wireless communication devices in a wireless communication network. The motion-sensing data may represent changes to a channel or disturbances of the wireless links caused by motion in a space associated with the wireless communication network.

At 730, a new motion zone is identified that is not associated with the wireless communication devices. The new motion zone is identified based on persistent link disturbance patterns. In some cases, the new motion zone is identified by the process 600 shown in FIG. 6, or another type of process may be used. For example, the new motion zone may be detected based on concurrent disturbance of multiple links in the wireless communication network. In various embodiments, the new motion zone may be, for example, the first region 502 or the second region 504 illustrated in FIG. 5A.

At 740, the new motion zone is presented to the user in graphical format. In various embodiments, a location of the new motion zone is illustrated relative to wireless communication devices in the space. For example, the new motion zone may be presented in a graphical representation of a spatial arrangement (or spatial map) of the wireless communication devices, and the graphical representation may be displayed on a display device. The spatial arrangement may be generated based on spatial coordinates. In various embodiments, the user is asked if the user prefers to have the new motion zone represented as a distinct motion zone in the motion detection system.

At 750, the system receives user input responsive to the presentation of the new motion zone and the inquiry. In various embodiments, the user may indicate that the user desires for the new motion zone to be independently represented or that the user prefers the new motion zone to be amalgamated with an existing motion zone that is associated with a wireless communication device. In some cases, the user may provide a name, label, or other information describing the new motion zone.

At 760, the system is updated based on the user's response to the inquiry. For example, user input may include names or labels for the new motion zones, and the motion detection system may be modified at 760 to associate the new names or labels with the respective new motion zones. As another example, the motion detection system may be modified to designate actions to be executed when motion is detected by the system. For example, the motion detection system may be programmed to send an instruction, command, or notification to a particular device when motion is detected in one or more of the new motion zones.

In various embodiments, at 760, a user device may be notified, or an internet-of-things (IoT) device may be instructed according to the settings (or modified settings). For example, in response to identifying one of the wireless communication devices in the selected group of the wireless communication devices as a location of the motion, a message indicating that motion was detected in the first motion zone may be generated. After generating the message, the message can be sent to a device associated with the motion detection system, such as an IoT device. As another example, in response to identifying one of the wireless communication devices in the selected group of the wireless communication devices as a location of the motion, instructions may be sent to a device associated with the motion detection system to alter a state of the device. In some instances, the state may be a power state, such as an on-off state.

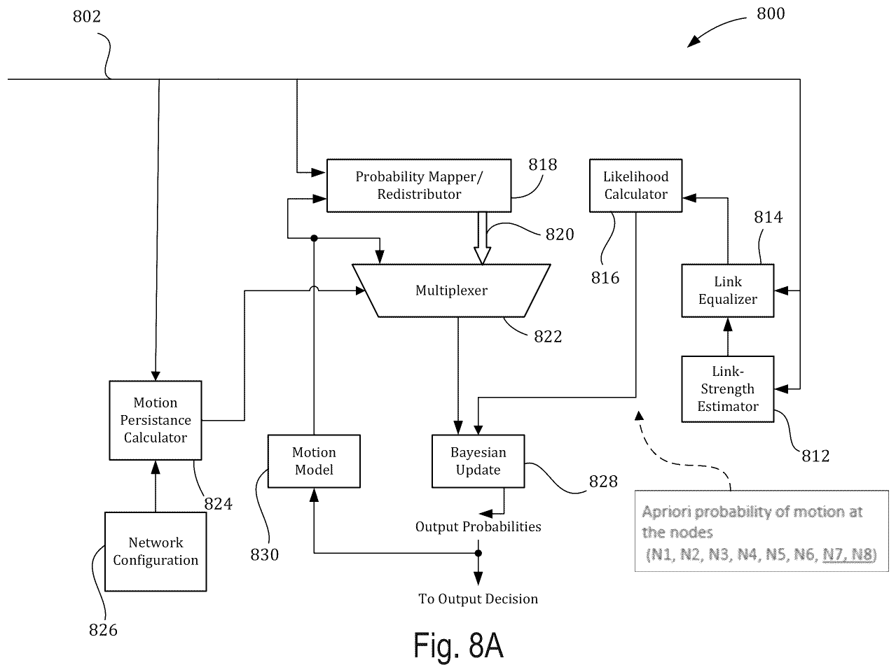

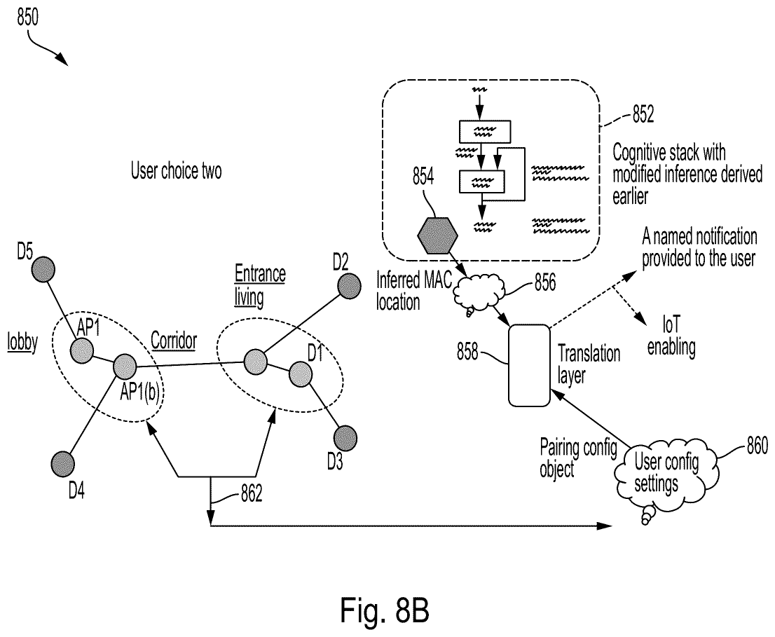

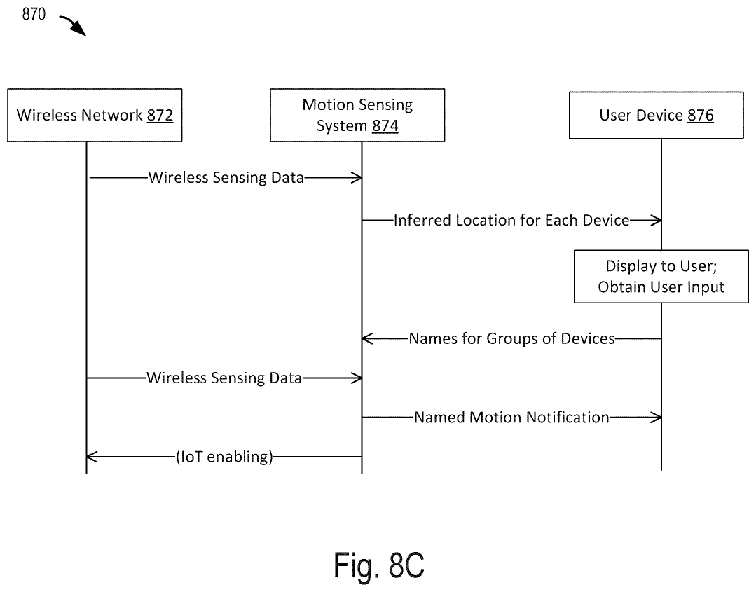

FIG. 8A is a flow chart of an example process 800 for determining a location of motion detected by one or more wireless links in a wireless communication network. The one or more wireless links may be part of a plurality of wireless links defined by respective pairs of wireless nodes, such as the wireless communication devices of FIGS. 4A-4B. The wireless communication network may include a data processing apparatus (e.g., one or more of the wireless nodes may serve as the data processing apparatus). Alternatively, the data processing apparatus may be communicatively coupled to the wireless communication network through a data connection (e.g., a wireless connection, a copper-wired connection, a fiber optic connection, etc.). The data processing apparatus may receive a data structure associated with a time frame, as shown by line 802. The data structure 802 may map the plurality of wireless links with their respective motion indicator values for the time frame. The plurality of wireless links may be represented by unique link identifiers in the data structure 802. However, other representations are possible. For example, the plurality of wireless links may be represented by respective pairs of unique node identifiers. In some instances, the data structure 802 may associate each of the unique link identifiers with a corresponding pair of unique node identifiers.

The data processing apparatus executes program instructions to alter one or more magnitudes of the set of motion indicator values to reference each motion indicator value to a common scale of wireless link sensitivity. More specifically, the data processing apparatus may function, in part, as a link strength estimator, such as shown by block 812, and a link equalizer, such as shown by block 814. The link strength estimator 812 and the link equalizer 814 receive an identity of wireless links that are present in the wireless communication network during the time frame as well as their respective motion indicator values. The link equalizer 814 also receives, from the link strength estimator 812, an equalization value for each of the identified wireless links. The link strength estimator 812 and the link equalizer 814 operate cooperatively to reference the motion indicator values of each identified wireless links to a common scale of wireless link sensitivity.

In operation, the link strength estimator 812 estimates a link strength of the identified wireless links by determining a statistical property of their respective motion indicator values. The statistical property may be a maximum motion indicator value, a deviation of a motion indicator value from a mean value, or a standard deviation. Other statistical properties are possible. In some instances, the link strength estimator 812 tracks the statistical properties of one or more respective motion indicator values over successive time frames. The statistical property may allow the link strength estimator 812 to gauge an excitation strength and corresponding dynamic range of a wireless link. Such gauging may account for a unique sensitivity of each identified wireless link. The link strength estimator 812 passes the determined statistical values to the link equalizer 814, which in turn, utilizes them as equalization values for respective motion indicator values. In particular, the link equalizer 814 divides the motion indicator value of each identified wireless link with its respective equalization value (or statistical property) to generate a normalized motion indicator value. In this manner, the link equalizer 814 “equalizes” the identified wireless links so that their respective responses to motion or other events may be compared independent of sensitivity.

For example, due to motion or another event, a first subset of wireless links may become strongly excited and exhibit correspondingly high dynamic ranges (or sensitivities). A second subset of wireless links may become weakly excited and exhibit correspondingly low dynamic ranges (or sensitivities) due to the same motion or event. Such excitations and corresponding dynamic ranges are reflected in the motion indicator values received by the link strength estimator 812 and the link equalizer 814. However, the link strength estimator 812 and link equalizer 814 operate cooperative to normalize the received motion indicator values to a common scale of wireless link sensitivity. Such normalization ensures that comparisons of the first and second sets of wireless links within the plurality of wireless links do not overweigh the first set of wireless links relative to the second set. Other benefits of normalization are possible.

The program instructions may further cause the data processing apparatus to identify a subset of wireless links based on a magnitude of their associated motion indicator values relative to the other motion indicator values in the set of motion indicator values. In particular, the data processing apparatus may receive the identified wireless links and their respective normalized motion indicator values from the link equalizer 814 and store this data in a memory associated with a likelihood calculator, such as shown by block 816. As part of this operation, the data processing apparatus may also receive the list of unique wireless nodes and store the list in the memory associated with the likelihood calculator 816. The data processing apparatus may function, in part, as the likelihood calculator 816.

The likelihood calculator 816 identifies a subset of wireless links based on a magnitude of their respective, normalized motion indicator values relative to other normalized motion indicator values. To do so, the likelihood calculator 816 may sort or filter through the normalized motion indicator values received from the link equalizer 814 to identify the subset of wireless links. For example, the link calculator 816 may sort the data structure according to magnitude to determine a highest normalized motion indicator value, thereby generating a subset of wireless links with a single wireless link. In another example, the link calculator 816 may sort the data structure according to magnitude to determine the three highest normalized motion indicator values, thereby generating a subset of wireless links with three wireless links. Other numbers of wireless links are possible for the subset of wireless links.

The link calculator 816 also generates count values for the wireless nodes connected to the wireless communication network during the time frame. The count value for each wireless node indicates how many wireless links in the subset of wireless links are defined by the wireless node. For example, and with reference to FIG. 3A, the link calculator 816 may identify a subset of wireless links based on the three highest normalized motion indicator values:

$$\{ \begin{matrix}0 & 0.00 \\ 1 & 0.00 \\ 2 & 0.24 \\ 3 & 0.36 \\ 4 & 0.40 \\ 5 & 0.65\end{matrix} \} \to \{ \begin{matrix}3 & 0.36 \\ 4 & 0.40 \\ 5 & 0.65\end{matrix} \}$$

The unique link identifiers of 3, 4, and 5 correspond to wireless nodes N₀, N₁, and N₂ as shown below:

$$\{ \begin{matrix}3 & 0.36 \\ 4 & 0.40 \\ 5 & 0.65\end{matrix} \} \to \{ \begin{matrix}7 f 4 c 9 e \to & 7 f 630 c & 0.36 \\ 7 f 630 c \to & 7 f 4440 & 0.40 \\ 7 f 630 c \to & 7 f 4 c 9 e & 0.65\end{matrix} \} \to \{ \begin{matrix}{N}_{1} & \to {N}_{2} & 0.36 \\ {N}_{2} & \to {N}_{0} & 0.40 \\ {N}_{2} & \to {N}_{1} & 0.65\end{matrix} \}$$

Here, wireless node N₀ assists in defining one wireless link in the subset of wireless links, i.e., N₂→No. Similarly, wireless node N₁ assists in defining two wireless links in the subset of wireless links, i.e., N₁→N₂ and N₂→N₁, and wireless node N₂ assists in defining three wireless links in the subset of wireless links, i.e., N₁→N₂, N₂→N₀, and N₂→N₁. Accordingly, the link calculator 616 generates count values of 1, 2, and 3 for respective wireless nodes N₀, N₁, and N₂. In the present example, all wireless nodes of the wireless communication network assist in defining a wireless link of the subset of wireless links. However, for wireless nodes that do not assist in defining a wireless link of the subset of wireless links, the link calculator 816 may generate a count value of zero. In some instances, the link calculator 816 generates a count-value data structure associating each wireless node connected to the wireless communication network during the time frame with its respective count value. For the present example, the link calculator 816 may generate the following the count-value data structure:

$$\{ \begin{matrix}{N}_{0} & 1 \\ {N}_{1} & 2 \\ {N}_{2} & 3\end{matrix} \}$$

Although wireless nodes in the count-value data structure are represented by the label, Nᵢ, where i represents a number of a wireless node, other representations are possible (e.g., pairs of partial MAC addresses).

The link calculator 816 further generates a probability vector based on the count values that include values for each wireless node connected to the wireless communication network during the time frame. The values for each connected wireless node represent a probability of motion at the connected wireless node during the time frame. In particular, the values may represent a probability that motion at (or proximate to) a respective wireless node induces link activity along a particular wireless link. In some instances, the values sum to unity. In these instances, the values may be probability values. The link calculator 816 passes the generated probability vector to a Bayesian update engine 828, as shown in FIG. 8A.

In some instances, the values for each connected wireless node are likelihood values assigned from a link likelihood map. The likelihood values may not necessarily sum to unity. The link likelihood map associates likelihood values with respective magnitudes of count values. The likelihood values and their associations may be predetermined and may further be stored in a memory of the link calculator 816 (or data processing apparatus). For example, if a wireless node is strongly represented in a subset of wireless links, motion detected by the wireless communication network will have a relatively high probability of being located at or near the wireless node. As such, the link likelihood map may associate high likelihood values with proportionately high count values. However, other associations of likelihood values and count values are possible.

In some variations, the probability vector is represented by a probability vector, P(Lⱼ|Nᵢ), that includes probability values based on the link likelihood map. The probability values correspond to probabilities that a wireless link, Lⱼ, exhibits link activity given motion at a wireless node, Nᵢ. For example, and with reference to FIG. 3A, the link calculator 816 may generate a subset of wireless links that includes only wireless link L₀₂, which has a unique link identifier of “1”. As such, P(Lⱼ|Nᵢ)=P(1|Nᵢ)={P(1|0), P(1|1), P (1|2)}. Here, P(1|0) corresponds to the probability that motion at wireless node 0 induces link activity along wireless link 1, P(1|1) corresponds to the probability that motion at wireless node 1 induces link activity along wireless link 1, and P(1|2) corresponds to the probability that motion at wireless node 2 induces link activity along wireless link 1. These probability values can be generated from likelihood values of the link likelihood map. For example, the link calculator 616 may assign wireless nodes 0, 1, and 2 each a likelihood value based on a respective count value. The link calculator 616 may then normalize the assigned likelihood values to unity, thereby generating corresponding probability values for each wireless node.

Still referring to FIG. 8A, in cases where the user actively wants the new zone to appear with a separate notification in, for example, a mobile app (for example when he walks into the corridor, he wants the corridor light to light up), the system establishes a distinct localization for this new motion zone. The new motion zone is added into the probabilistic inference stack. In earlier probabilistic inference stacks, all of the nodes utilized for localization of motion corresponded to physical devices located within the space such as, for example, the space 400 (e.g., N1, N2, N3 etc, corresponding to devices D1, D2, D3). In this case, a node is added to the inference stack, which has no corresponding device associated with it. By way of example, the link calculator 816 passes a probability vector to the Bayesian update 828 containing apriori probability of motion at nodes N1, N2, N3, N4, N5, N6, N7, and N8. By way of example, nodes N7 and N8 do not have devices D7 and D8 illustrated in FIGS. 5A and 5C, so these nodes do not correspond to physical devices. Once the nodes N7 and N8 are instantiated in the probability table, the inference stack will treat them as nodes associated with wireless communication devices. Whenever the link pattern corresponding to these nodes appears, the system assigns a high likelihood of motion to N7 or N8 (depending on which links were disturbed). For example, if L1 and L3 links are disturbed, it is likely that the motion is happening in the first area 502 of FIG. 5A and if the node corresponding to the first area 502 is called N8 by the user, the highest likelihood of motion is assigned to N8. This is then combined with the bayesian prior probability, to compute the final probability of motion at all the nodes.

Still referring to FIG. 8A, the data processing apparatus also executes program instructions to pass, to a probability mapper/redistributor, the list of unique wireless nodes present in the wireless communication network during the time frame. The data processing apparatus may function, in part, as a probability mapper/redistributor, such as shown by block 818. As part of this operation, the data processing apparatus may receive a probability vector generated prior to the time frame, e.g., a prior probability vector. The probability mapper/redistributor 818 is operable to determine a change in wireless connectivity between time frames, such as between a prior time frame and a subsequent time frame. The change in wireless connectivity may include one or both of: [1] wireless nodes that have connected to the wireless communication network between the prior and subsequent time frames, or [2] wireless nodes that have disconnected from the wireless communication network between the prior and subsequent time frames. To determine the change in wireless connectivity, the probability mapper/redistributor 618 may compare the list of unique wireless nodes in the time frame to wireless nodes represented in the probability vector generated prior to the time frame.

The probability mapper/redistributor 818 is also operable to generate an initialization probability vector of a plurality of initialization probability vectors 820 by altering values of the prior probability vector based on the change in wireless connectivity. For example, the change in wireless connectivity may include a wireless node that has disconnected from the wireless communication network between the prior and subsequent time frames. In this case, the probability mapper/redistributor 818 may generate the initialization probability vector by apportioning values of the prior probability vector associated with the disconnected wireless node to values of wireless nodes that have remained connected to the wireless communication network. Such apportioning may occur in ratios defined by the values of the remaining wireless nodes. However, other apportioning schedules are possible. In another example, the change in wireless connectivity may include a wireless node that has connected from the wireless communication network between the prior and subsequent time frames. In this case, the probability mapper/redistributor 818 generates the initialization probability vector by adding a value to the prior probability vector for the newly-connected wireless node.

The probability mapper/redistributor 818 may be operable to generate other types of initialization probability vectors that correspond to reset states. For example, if the wireless communication network (or motion detection system) is cold-started, the probability mapper/redistributor 818 may generate an initialization probability vector by assigning equal probability values to all unique wireless nodes. In another example, if the wireless communication network (or motion detection system) is warm-started, the probability mapper/redistributor 818 may generate an initialization probability vector based on probability values that correspond to a time frame when motion was last detected. In yet another example, if the wireless communication network (or motion detection system) is operational but later reset, the probability mapper/redistributor 818 may utilize the prior probability vector as the initialization probability vector. In yet another example, if a user notifies the wireless communication network (or motion detection system) that he/she is leaving a monitored residence (e.g., through a mobile software application), the probability mapper/redistributor 818 may generate an initialization probability vector with probability values biased towards wireless nodes at a point of entry (e.g., a front door).

The probability mapper/redistributor 818 passes the plurality of initialization probability vectors 820 to a multiplexor (or mux), which also receives the prior probability vector from a motion model. The data processing apparatus may function, in part, as the multiplexor, such as shown by block 822. The multiplexor 822 is operable to select the prior probability vector or one of the plurality of initialization probability vectors based on the set of motion indicator values, a configuration of the wireless communication network, or both. The selected probability vector is then passed to the Bayesian update engine 828, as shown in FIG. 8A. In order to determine which probability vector to select, the multiplexor 822 receives a control input from a motion persistence calculator, as shown by block 824. The motion persistence calculator 824 receives the data structure 802, which includes the set of motion indicator values, and also receives a configuration of the wireless communication network 826. Based on these inputs, the motion persistence calculator 824 generates the control signal, which when received by the multiplexor 822, selects which of the prior probability vector or one of the plurality of initialization probability vectors is passed to the Bayesian update engine 828. If motion is continuously detected by the wireless communication network (or motion detection system), the motion persistence calculator 824 may keep passing a prior probability vector through the multiplexor 822. In contrast, if motion is detected after a period of absence, the motion persistence calculator 824 may pass an initialization probability vector through the multiplexor 822 that corresponds to a reset state. The data processing apparatus may also function, in part, as the motion persistence calculator 824.

In some implementations, the data processing apparatus uses the selected probability vector and a set of motion indicator values associated with a second subsequent time frame to identify a location associated with motion that occurred during the subsequent time frame. In particular, the data processing apparatus executes program instructions to generate, from a first probability vector received from the likelihood calculator 816 and a second probability vector received from the multiplexor 822, a third probability vector that includes third values for each wireless node. In particular, the Bayesian update engine generates the third probability vector, as shown by block 828. The third values of the third probability vector represent probabilities of motion at the respective wireless nodes during the time frame.

In some variations, the second probability vector is represented by a probability vector, P(Nᵢ), that includes probability values (or second values) representing a probability of motion at a wireless node, Nᵢ. The probability of motion at wireless node, Nᵢ, for P(Nᵢ) is independent of link activity along any of wireless links, Lⱼ, and may also be independent of other factors. For example, and with reference to FIG. 3A, the program instructions may cause the data processing apparatus to define P(Nᵢ) according to P(Nᵢ)={P(0), P(1), P(2)}. Here, P(Nᵢ) has probability values of P(0), P(1), and P(2), which correspond to the probability of motion at (or proximate to) wireless nodes 0, 1, and 2, respectively.

In some variations, the third probability vector is represented by P(Nᵢ|Lⱼ), where Nᵢ corresponds to the unique node identifier and Lⱼ corresponds to the unique link identifier. The third probability vector, P(Nᵢ|Nⱼ), includes third values that represent a probability of motion at wireless node, Nᵢ, given link activity along wireless link, Lⱼ. For example, if Lⱼ corresponds to wireless link 1 in the wireless communication network 300 of FIG. 3A, the respective third values may then be represented by P(0|1), P(1|1), and P(2|1), where P(Nᵢ|1)={P(0|1), P(1|1), P(2|1)}. Here, P(0|1) corresponds to a probability that link activity along wireless link 1 results from motion at wireless node 0, P(1|1) corresponds to a probability that link activity along wireless link 1 results from motion at wireless node 1, and P(2|1) corresponds to a probability that link activity along wireless link 1 results from motion at wireless node 2.

The third probability vector, P(Nᵢ|Lⱼ), may be determined by the Bayesian update engine 828 according to Eq. (1):

$$P ( {N}_{i} \vert {L}_{j} ) = \frac{P ( {L}_{j} \vert {N}_{i} ) \cdot P ( {N}_{i} )}{{\sum }_{i} P ( {L}_{j} \vert {N}_{i} ) P ( {N}_{i} )} \qquad ( 1 )$$

where P(Lⱼ|Nᵢ) and P(Nᵢ) are as described above for, respectively, the first probability vector from the likelihood calculator 616 and the second probability vector from the multiplexor 822. Eq. (1) may allow the wireless communication network 300 (or data processing apparatus) to determine the location of detected motion using Bayesian statistics. For example, if in the wireless communication network 300 of FIG. 3A, the subset of wireless links includes only wireless link 1 and P(1|Nᵢ)={1, 0.2, 0.9} based on the link likelihood map, the program instructions may then cause the data processing apparatus to calculate the third probability vector, P(Nᵢ|1), according to:

$$P ( {N}_{i} \vert 1 ) = \frac{P ( 1 \vert {N}_{i} ) \cdot P ( {N}_{i} )}{{\sum }_{i} P ( 1 \vert {N}_{i} ) P ( {N}_{i} )} = \frac{\{ 1. \cdot 0.333 , 0.2 \cdot 0.333 , 0.9 \cdot 0.333 \}}{( 1. \cdot 0.333 ) + ( 0.2 \cdot 0.333 ) + ( 0.9 \cdot 0.333 )}$$

Such calculation results in P(Nᵢ|1)={0.476, 0.095, 0.429}, with the third values summing to unity, i.e., 0.476+0.095+0.429=1. P(Nᵢ|1) may therefore represent a probability distribution normalized to unity. In P(Nᵢ|1), P(0|1) corresponds to the largest of the third values, indicating that motion detected by the wireless communication network 300 along wireless link 1 has the highest probability of being located at (or proximate to) wireless node 0. Based on this value of P(0|1), the program instructions may cause the data processing apparatus to look up the MAC address value of wireless node 0, and when found, output the result (e.g., output 7f4440).

In some implementations, the data processing apparatus performs an iterative process for sequential time frames. For example, the data processing apparatus may repeat the operations, over multiple iterations for respective time frames, of obtaining the set of motion indicator values associated with a subsequent time frame, identifying the subset of wireless links based on a magnitude of their associated motion indicator values relative to other motion indicator values in the set of motion indicator values, generating the count values for the wireless nodes connected to the wireless communication network during the subsequent time frame, generating the first probability vector based on the count values and including values for the connected wireless nodes. In some implementations, the repeated operations include obtaining a set of motion indicator values associated with a prior time frame, generating a prior probability vector associated with the prior time frame, generating a second probability vector by selecting the prior probability vector or one of the plurality of initialization probability vectors to identify a location associated with motion that occurred during the subsequent time frame.

In some implementations, the repeated operations may include generating a third probability vector based on the first values of the first probability vector and the second values of the second probability vector; identifying a wireless communication device associated with the highest of the third values; and identifying, by operation of a data processing apparatus, a location associated with the identified wireless communication device as a location of the motion detected from the wireless signals exchanged during the subsequent time frame.

An output of the Bayesian update engine 828 may be fed into the motion model to generate the prior probability vector (or second probability vector), which is passed to the probability mapper/redistributor 818 and the multiplexor 822. The data processing apparatus may function, in part, as the motion model, as shown by block 830. The motion model 830 may operate analogous to calculating probabilities on a trellis.

FIG. 8B is a block diagram illustrating interaction of a user with a motion detection system. When the user has indicated that he does not want a new motion zone to be displayed with a separate notification, such functionality is enabled with a config object. In various embodiments, the config object may, for example, take the user choice, and understand that the user wants, for example, N8, and N2 to be considered to be the same zone. So, if the motion is localized to either N2 or N8, the user still gets the notification of N2. Further, any IoT trigger that is assigned to N2 will be enabled. FIG. 8B illustrates a localization stack 852 running on a router 854 producing predictions of localization 856, and sending them to the user device 858. In various embodiments, the user device, may be, for example, a smart phone, a tablet, a cellular device, a computer, or any other user device capable of receiving wireless signals. FIG. 8B further illustrates a config object 860 that has taken user preferences 862 into account. In various embodiments, the user preferences 862 could be, for example, if the user wants to fuse two new motion zones or keep them separate. The localization data 856, together with the user preferences 862, is then used to control any IoT devices that the user has configured with the localization enabled IoT apps.

FIG. 8C is a signaling and flow diagram representing example operations that may be performed in the system 870 shown in FIG. 8B. As shown in FIG. 8C, the wireless network 872 sends wireless sensing data to the motion sensing system 874. The motion sensing system 874 can then infer a location for new motion zones in the wireless network 872 based on the motion sensing data (e.g., as described above with respect to FIGS. 4A, 4B, 5A-5C, or otherwise). The inferred location information is then sent to the user device 876, which displays a graphical representation of the spatial arrangement of the new motion zones to the user. The user device 876 then obtains user input in response to the graphical representation. The user input includes a selection of whether the user desires to have the new motion zones considered separately or integrated with existing motion zones (e.g., as described with respect to FIG. 6). If the user selects that the new motion zones should be considered separately, the user may provide a name for the new motion zone (e.g., “corridor”). The user device 876 then sends information to the motion sensing system 874 based on the user input, and the motion sensing system 874 defines (or updates) motion zones based on the information from the user device 876. Later, the wireless network 872 sends wireless sensing data to the motion sensing system 874, which detects motion of an object based on the wireless sensing data. The motion sensing system 874 may then send a message to the user device 876, to the wireless network 872, to another system or device, or to multiple systems or devices. For example, the message may notify the user device 876 that motion was detected in a motion zone, and the notification may include the name (e.g., “corridor”) that was provided by the user. As another example, the message may include an instruction or command for a smart device in the wireless network 872. For instance, the instruction may modify a light setting, a temperature setting, activate or deactivate a device, or perform another action.

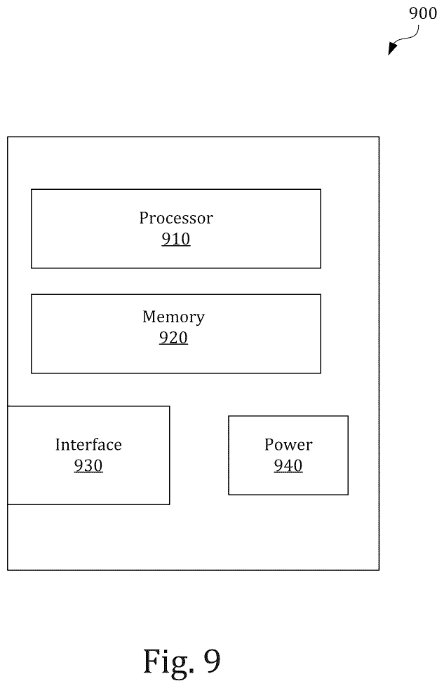

FIG. 9 is a block diagram showing an example wireless communication device 900. As shown in FIG. 9, the example wireless communication device 900 includes an interface 930, a processor 910, a memory 920, and a power unit 940. A wireless communication device (e.g., any of the wireless communication devices 102A, 102B, 102C in FIG. 1) may include additional or different components, and the wireless communication device 900 may be configured to operate as described with respect to the examples above. In some implementations, the interface 930, processor 910, memory 920, and power unit 940 of a wireless communication device are housed together in a common housing or other assembly. In some implementations, one or more of the components of a wireless communication device can be housed separately, for example, in a separate housing or other assembly.

The example interface 930 can communicate (receive, transmit, or both) wireless signals. For example, the interface 930 may be configured to communicate radio frequency (RF) signals formatted according to a wireless communication standard (e.g., Wi-Fi, 4G, 5G, Bluetooth, etc.). In some implementations, the example interface 930 includes a radio subsystem and a baseband subsystem. The radio subsystem may include, for example, one or more antennas and radio frequency circuitry. The radio subsystem can be configured to communicate radio frequency wireless signals on the wireless communication channels. As an example, the radio subsystem may include a radio chip, an RF front end, and one or more antennas. The baseband subsystem may include, for example, digital electronics configured to process digital baseband data. In some cases, the baseband subsystem may include a digital signal processor (DSP) device or another type of processor device. In some cases, the baseband system includes digital processing logic to operate the radio subsystem, to communicate wireless network traffic through the radio subsystem or to perform other types of processes.

The example processor 910 can execute instructions, for example, to generate output data based on data inputs. The instructions can include programs, codes, scripts, modules, or other types of data stored in memory 920. Additionally or alternatively, the instructions can be encoded as pre-programmed or re-programmable logic circuits, logic gates, or other types of hardware or firmware components or modules. The processor 910 may be, or include, a general-purpose microprocessor, as a specialized co-processor, or another type of data processing apparatus. In some cases, the processor 910 performs high level operation of the wireless communication device 900. For example, the processor 910 may be configured to execute or interpret software, scripts, programs, functions, executables, or other instructions stored in the memory 920. In some implementations, the processor 910 may be included in the interface 930 or another component of the wireless communication device 900.

The example memory 920 may include computer-readable storage media, for example, a volatile memory device, a non-volatile memory device, or both. The memory 920 may include one or more read-only memory devices, random-access memory devices, buffer memory devices, or a combination of these and other types of memory devices. In some instances, one or more components of the memory can be integrated or otherwise associated with another component of the wireless communication device 900. The memory 920 may store instructions that are executable by the processor 910. For example, the instructions may include instructions to perform one or more of the operations in the example process 700 shown in FIG. 7.

The example power unit 940 provides power to the other components of the wireless communication device 900. For example, the other components may operate based on electrical power provided by the power unit 940 through a voltage bus or other connection. In some implementations, the power unit 940 includes a battery or a battery system, for example, a rechargeable battery. In some implementations, the power unit 940 includes an adapter (e.g., an AC adapter) that receives an external power signal (from an external source) and converts the external power signal to an internal power signal conditioned for a component of the wireless communication device 900. The power unit 920 may include other components or operate in another manner.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to, and receiving documents from, a device that is used by the user; for example, by sending web pages to a web browser on a user's client device in response to requests received from the web browser.

In a general aspect, the systems and techniques described herein allow for identifying motion zones based on user input and motion-sensing data derived from wireless signals.

In a first example, a method includes identifying a plurality of motion zones in a motion detection system. Each of the plurality of motion zones represents a distinct region in a space associated with a wireless communication network. At least a subset of the motion zones are associated with respective wireless communication devices in the wireless communication network. The method also includes generating motion-sensing data based on first wireless signals transmitted, during a first time period, between pairs of wireless communication devices in the wireless communication network. The motion-sensing data represents motion in the space. The method also includes identifying, based on the motion-sensing data, a new motion zone that is not associated with any of the wireless communication devices, and receiving user input in response to a graphical representation of the new motion zone that is displayed on a display device. The method includes updating the motion detection system based on the user input.

Implementations of the first example may include one or more of the following features. For example, the graphical representation may indicate the locations of the plurality of motion zones relative to the new motion zone. Further, implementations of the first example may include generating, based on motion-sensing data obtained by the motion detection system, spatial coordinates for the respective wireless communication devices, the spatial coordinates for each wireless communication device representing a location of the wireless communication device in the space, and the graphical representation indicates the locations of the wireless communication devices relative to the new motion zone. Further still, implementations of the first example may include adding the new motion zone to a dictionary of effective zones in the wireless communication network.

Implementations of the first example may include one or more of the following features. For example, motion of an object is detected in the space. The detection of motion is based on second wireless signals that are transmitted between one or more pairs of the wireless communication devices during a second time period. Additionally, in response to identifying the new motion zone as a location of the detected motion of the object, a message is generated that indicates that motion was detected in the new motion zone. The message is sent to a device associated with the motion detection system.

Implementations of the first example may include one or more of the following features. For example, likelihood values for pairs of the wireless communication devices are generated based on the first motion-sensing data. The likelihood value for each pair of wireless communication devices represents a likelihood of sensing motion at the pair of wireless communication devices sequentially in time. Further, distance values are generated for the respective pairs of wireless communication devices. The distance values for each pair of wireless communication devices represent a distance between two of the wireless communication devices. Further, spatial coordinates are generated based on the distance values.

Implementations of the first example may include one or more of the following features. The user input indicates a name associated with the new motion zone. The name is associated with the new motion zone, and the message indicates the name associated with the new motion zone. Sending the message to the device associated with the motion detection system comprises sending the notification to the user device.

Implementations of the first example may include one or more of the following features. Likelihood values are generated for pairs of the wireless communication devices based on the first motion-sensing data. The likelihood value for each pair of wireless communication devices represents a likelihood of sensing motion at the pair of wireless communication devices sequentially in time. Distance values for the respective pairs of wireless communication devices are generated based on the likelihood values. The distance value for each pair of wireless communication devices represents a distance between two of the wireless communication devices. Spatial coordinates are generated based on the distance values.

In a second example, a system includes a plurality of wireless communication devices, and a computer device configured to perform one or more operations of the first example.

In a third example, a non-transitory computer-readable medium stores instructions that are operable when executed by data processing apparatus to perform one or more operations of the first example.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method comprising:
identifying a plurality of motion zones in a motion detection system, each of the plurality of motion zones representing a distinct region in a space associated with a wireless communication network, at least a subset of the motion zones being associated with respective wireless communication devices in the wireless communication network;
obtaining motion-sensing data based on first wireless signals transmitted, during a first time period, between pairs of wireless communication devices in the wireless communication network, the motion-sensing data representing motion in the space;
based on the motion-sensing data, identifying a new motion zone that is not associated with any of the wireless communication devices;
receiving user input in response to a graphical representation of the new motion zone being displayed on a display device; and
updating the motion detection system based on the user input.

2. The method of claim 1, wherein identifying the new motion zone comprises:
classifying subsets of the motion-sensing data;
based on a classification of a first subset of the motion-sensing data, applying a statistical significance test to the first subset of the motion-sensing data; and
responsive to a determination that the first subset of motion-sensing data is statistically significant, defining the new motion zone corresponding to the first subset motion-sensing data.

3. The method of claim 2, wherein the wireless communication network comprises a plurality of wireless links, and the subsets of the motion-sensing data correspond to respective subsets of the wireless links.

4. The method of claim 3, wherein:
classifying the subsets of the motion-sensing data comprises classifying each subset of the motion-sensing data as one of:
corresponding to one of the motion zones that are associated with respective wireless communication devices, or
not corresponding to one of the motion zones that are associated with respective wireless communication devices;
the first subset of motion-sensing data is classified as not corresponding; and
the method comprises applying the statistical significance test to each subset of motion-sensing data classified as not corresponding.

5. The method of claim 1, wherein the graphical representation indicates the locations of the plurality of motion zones relative to the new motion zone.

6. The method of claim 1, comprising, based on motion-sensing data obtained by the motion detection system, generating spatial coordinates for the respective wireless communication devices, the spatial coordinates for each wireless communication device representing a location of the wireless communication device in the space, and the graphical representation indicates the locations of the wireless communication devices relative to the new motion zone.

7. The method of claim 6, wherein generating the spatial coordinates comprises:
generating, based on the motion-sensing data, likelihood values for pairs of the wireless communication devices, the likelihood value for each pair of wireless communication devices representing a likelihood of sensing motion at the pair of wireless communication devices sequentially in time;
generating, based on the likelihood values, distance values for the respective pairs of wireless communication devices, the distance value for each pair of wireless communication devices representing a distance between two of the wireless communication devices; and
generating the spatial coordinates based on the distance values.

8. The method of claim 1, wherein updating the motion detection system comprises adding the new motion zone to a dictionary of effective zones in the motion detection system.

9. The method of claim 8, wherein:
the user input indicates a name associated with the new motion zone;
defining the motion zone comprises associating the name with the new motion zone;
the message indicates the name associated with the new motion zone; and
sending the message to the device associated with the motion detection system comprises sending the notification to the user device.

10. The method of claim 1, further comprising:
by operation of the motion detection system, detecting motion of an object in the space based on second wireless signals transmitted between one or more pairs of the wireless communication devices during a second time period;
in response to identifying the new motion zone as a location of the detected motion of the object, generating a message indicating that motion was detected in the new motion zone; and
sending the message to a device associated with the motion detection system.

11. A system comprising one or more processors operable to perform operations comprising:
identifying a plurality of motion zones in a motion detection system, each of the plurality of motion zones representing a distinct region in a space associated with a wireless communication network, at least a subset of the motion zones being associated with respective wireless communication devices in the wireless communication network;
obtaining motion-sensing data based on first wireless signals transmitted, during a first time period, between pairs of wireless communication devices in the wireless communication network, the motion-sensing data representing motion in the space;
based on the motion-sensing data, identifying a new motion zone that is not associated with any of the wireless communication devices;
receiving user input in response to a graphical representation of the new motion zone being displayed on a display device; and
updating the motion detection system based on the user input.

12. The system of claim 11, wherein identifying the new motion zone comprises:
classifying subsets of the motion-sensing data;
based on a classification of a first subset of the motion-sensing data, applying a statistical significance test to the first subset of the motion-sensing data; and
responsive to a determination that the first subset of motion-sensing data is statistically significant, defining the new motion zone corresponding to the first subset motion-sensing data.

13. The system of claim 12, wherein the wireless communication network comprises a plurality of wireless links, and the subsets of the motion-sensing data correspond to respective subsets of the wireless links.

14. The system of claim 13, wherein:
classifying the subsets of the motion-sensing data comprises classifying each subset of the motion-sensing data as one of:
corresponding to one of the motion zones that are associated with respective wireless communication devices, or
not corresponding to one of the motion zones that are associated with respective wireless communication devices;
the first subset of motion-sensing data is classified as not corresponding; and
the operations comprise applying the statistical significance test to each subset of motion-sensing data classified as not corresponding.

15. The system of claim 11, wherein the graphical representation indicates the locations of the plurality of motion zones relative to the new motion zone.

16. The system of claim 11, comprising, based on motion-sensing data obtained by the motion detection system, generating spatial coordinates for the respective wireless communication devices, the spatial coordinates for each wireless communication device representing a location of the wireless communication device in the space, and the graphical representation indicates the locations of the wireless communication devices relative to the new motion zone.

17. The system of claim 16, wherein generating the spatial coordinates comprises:
generating, based on the motion-sensing data, likelihood values for pairs of the wireless communication devices, the likelihood value for each pair of wireless communication devices representing a likelihood of sensing motion at the pair of wireless communication devices sequentially in time;
generating, based on the likelihood values, distance values for the respective pairs of wireless communication devices, the distance value for each pair of wireless communication devices representing a distance between two of the wireless communication devices; and
generating the spatial coordinates based on the distance values.

18. The system of claim 11, wherein updating the motion detection system comprises adding the new motion zone to a dictionary of effective zones in the motion detection system.

19. The system of claim 18, wherein:
the user input indicates a name associated with the new motion zone;
defining the motion zone comprises associating the name with the new motion zone;
the message indicates the name associated with the new motion zone; and
sending the message to the device associated with the motion detection system comprises sending the notification to the user device.

20. The system of claim 11, the operations comprising:
by operation of the motion detection system, detecting motion of an object in the space based on second wireless signals transmitted between one or more pairs of the wireless communication devices during a second time period;
in response to identifying the new motion zone as a location of the detected motion of the object, generating a message indicating that motion was detected in the new motion zone; and
sending the message to a device associated with the motion detection system.

21. A non-transitory computer-readable medium comprising instructions that are operable, when executed by data processing apparatus, to perform operations comprising:
identifying a plurality of motion zones in a motion detection system, each of the plurality of motion zones representing a distinct region in a space associated with a wireless communication network, at least a subset of the motion zones being associated with respective wireless communication devices in the wireless communication network;
generating motion-sensing data based on first wireless signals transmitted, during a first time period, between pairs of wireless communication devices in the wireless communication network, the motion-sensing data representing motion in the space;
based on the motion-sensing data, identifying a new motion zone that is not associated with any of the wireless communication devices;
receiving user input in response to a graphical representation of the new motion zone being displayed on a display device; and
updating the motion detection system based on the user input.
